(19) United States
(12) Patent Application Publication
(10) Pub. No.: US 2006/0136335 A1
(43) Pub. Date: Jun. 22, 2006

(54) System and methods for accessing high-profile individuals

(76) Inventor: Joseph M. Ferguson III, Atlanta, GA (US)

Correspondence Address: Gerald R. Boss;TROUTMAN SANDERS LLP, Bank of America Plaza, 600 Peachtree Street, N.E., Suite 5200, Atlanta, GA, 30308-2216, US

(21) Appl. No.: 11/302,912

(22) Filed: Dec. 14, 2005

Related U.S. Application Data
(60) Provisional application No. 60/637,216, filed on Dec. 17, 2004.

(51) Int. Cl. G06Q 99/00; G06Q 40/00

(52) U.S. Cl. 705/40; 705/1

(57) ABSTRACT

A system and methods of providing access to high-profile individuals within a high-profile individual communication system. A communication and an offer amount are received from a user and provided to a high-profile individual. The high-profile individual is under no obligation to respond to the communication. Additionally, the user does not have to pay the offer amount, until the high-profile individual responds to the communication. If the high-profile individual responds to the communication, then a payment equal to the offer amount is collected from the user prior to providing the response of the high-profile individual to the user. Subsequently, a predetermined percentage of the received payment is provided to the high-profile individual for responding to the communication. The user may then rate the response of the high-profile individual, so that other users can determine an appropriate offer amount when attempting to communicate with the high-profile individual.

### CROSS REFERENCE TO RELATED APPLICATION AND CLAIM OF BENEFIT

This application claims the benefit of U.S. Provisional Application 60/637,216, filed on Dec. 17, 2004.

### TECHNICAL FIELD

The present invention relates, generally, to a system and methods for accessing high-profile individuals and, more specifically, to system and methods for accessing high-profile individuals using offer incentives.

### BACKGROUND OF THE INVENTION

In society, certain individuals receive elevated popularity, admiration, and/or exposure compared to ordinary individuals. Famous or infamous, these high-profile individuals are widely known by others and often gain followers in the form of fans. The lives of high-profile individuals and ordinary individuals seem worlds apart, especially in terms of accessibility or the lack thereof. Often considered unreachable, many high-profile individuals are only accessible to ordinary individuals indirectly through mediums such as movies, television, magazines, and newspapers.

Fans of authors, actors, actresses, artists, politicians, business celebrities, sport celebrities, musicians, radio celebrities, and other high-profile individuals generally possess limited or inadequate means for communicating with high-profile individuals. Although fan clubs fulfill their intended purposes, members all too often find disappointment in generic and impersonal responses to their letters, if a response is even received at all. The lack of opportunity to communicate with a high-profile individual leaves the many questions of ordinary individuals unanswered.

High-profile individuals are often inundated with communications from ordinary individuals, which cannot be properly addressed under limited time constraints. Additionally, high-profile individuals are generally reluctant to provide substantive responses to received communications, because of a lack of incentive to invest the time and resources for an adequate response. Further, to protect themselves from a potential fanatic (e.g., stalker), high-profile individuals often refrain from communicating with unfamiliar individuals.

Presently, a reliable connection between high-profile individuals and ordinary individuals does not exist. While advances in technology have improved communication methods, no technology has been able to overcome the invisible barrier between the famous and the fans. More specifically, no technology currently provides a medium for communication between high-profile individuals and ordinary individuals, while incorporating safeguards to protect a high-profile individual's privacy and ensure a quality response to ordinary individuals.

Accordingly, there is a need in the art for a high-profile individual communication system that provides users with accessibility to high-profile individuals.

There is also a need in the art for a high-profile individual communication system that entices high-profile individuals to respond to communications from users.

Additionally, there is a need in the art for a high-profile individual communication system that permits high-profile individuals to ban a user from sending communications to the high-profile individual.

Further, there is a need in the art for a high-profile individual communication system that allows users to rate a response from a high-profile individual, in order to provide quality control of the responses from high-profile individuals.

### SUMMARY OF THE INVENTION

Broadly described, the present invention comprises a system and methods of providing access to high-profile individuals within a high-profile individual communication system. A communication and an offer amount are received from a user and provided to a high-profile individual. The high-profile individual is under no obligation to respond to the communication and, therefore, may respond to all, some, or none of the received communications. Additionally, the user does not have to pay the offer amount, until the high-profile individual responds to the communication. If the high-profile individual responds to the communication, then a payment equal to the offer amount is collected from the user prior to providing the response of the high-profile individual to the user. Subsequently, a predetermined percentage of the received payment is provided to the high-profile individual for responding to the communication. The user may then rate the response of the high-profile individual, so that other users can determine an appropriate offer amount when attempting to communicate with the high-profile individual.

More specifically, the present invention comprises a system and methods of providing access to high-profile individuals within a high-profile individual communication system using electronic mail, web interfaces, audio, video, or other appropriate communication medium. High-profile individuals create accounts (register) within the high-profile individual communication system by submitting personal data, payment preferences, biographical data, and response restrictions or requirements. The response from the high-profile individual includes general specifications (e.g., parameters and/or guidelines) that can be determined by the high-profile individual, such that the user can determine what type of response to expect from the high-profile individual prior to making an offer. Users also create accounts (register) within the high-profile individual communication system by providing personal data and payment information. Only registered users, which have not been blocked by a high-profile individual, are permitted to send communications to any registered high-profile individual. Users may search for high-profile individuals directly by name or indirectly by category. Additionally, communications and offer amounts provided by a registered user may only be valid (open offers) for a predetermined period of time, which could be set by the user. If the high-profile individual has not responded prior to the expiration of the predetermined period of time, then the communication and offer amount are removed from the high-profile individual communication system. Users may also request that high-profile individuals, not currently registered with the high-profile individual communication system, be invited to join the high-profile individual communication system.

Other features and advantages of the present invention will become apparent upon reading and understanding the present specification when taken in conjunction with the appended drawings.

### BRIEF DESCRIPTION OF DRAWINGS

FIG. 1 displays a block diagram representation of a high-profile individual communication system environment in accordance with some embodiments of the present invention.

FIG. 2 displays a block diagram representation of a computing environment which may be utilized in accordance with some embodiments of the present invention.

FIG. 3 displays a block diagram representation of a high-profile individual communication system in accordance with some embodiments of the present invention.

FIG. 4 displays a pictorial representation of a user account registration interface in accordance with some embodiments of the present invention.

FIGS. 5A-5B, collectively known as FIG. 5, display a pictorial representation of a high-profile individual account registration interface in accordance with some embodiments of the present invention.

FIG. 6 displays a pictorial representation of a high-profile individual search interface in accordance with some embodiments of the present invention.

FIG. 7 displays a pictorial representation of a high-profile individual biographical profile interface in accordance with some embodiments of the present invention.

FIG. 8 displays a pictorial representation of a user communication interface in accordance with some embodiments of the present invention.

FIG. 9 displays a pictorial representation of a high-profile individual communication selection interface in accordance with some embodiments of the present invention.

FIG. 10 displays a pictorial representation of a high-profile individual communication interface in accordance with some embodiments of the present invention.

FIG. 11 displays a pictorial representation of a user communication display and rating interface in accordance with some embodiments of the present invention.

FIG. 12 displays a pictorial representation of a high-profile individual communication block interface in accordance with some embodiments of the present invention.

FIG. 13 displays a pictorial representation of a high-profile individual request interface in accordance with some embodiments of the present invention.

FIG. 14 displays a logic flow diagram representing a method of communicating with a high-profile individual in accordance with some embodiments of the present invention.

FIG. 15 displays a logic flow diagram representing a method of creating a high-profile individual account in accordance with some embodiments of the present invention.

FIG. 16 displays a logic flow diagram representing a method of creating a user account in accordance with some embodiments of the present invention.

FIG. 17 displays a logic flow diagram representing a method of verifying a user for communication with a high-profile individual in accordance with some embodiments of the present invention.

FIG. 18 displays a logic flow diagram representing a method of communicating with a high-profile individual with time limitations in accordance with some embodiments of the present invention.

FIG. 19 displays a pictorial representation of an advanced income user account registration interface in accordance with some embodiments of the present invention.

FIG. 20 displays a pictorial representation of a user advertisement selection interface in accordance with some embodiments of the present invention.

### DETAILED DESCRIPTION OF THE INVENTION

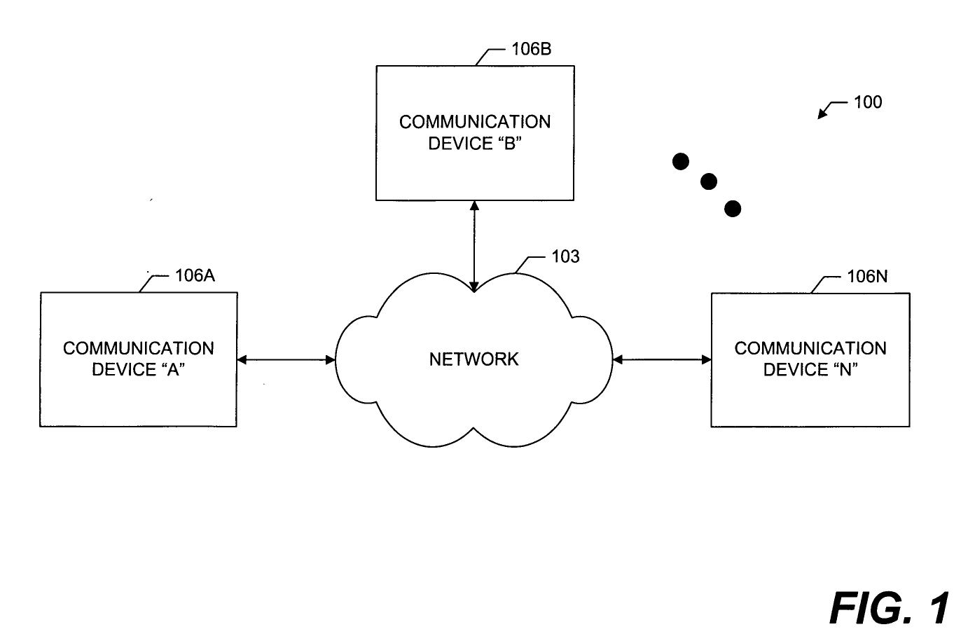

Referring now to the drawings, in which like numerals represent like components or steps throughout the several views, FIG. 1 displays a block diagram representation of a high-profile individual communication system environment 100 in accordance with some embodiments of the present invention. The high-profile individual communication system environment 100 comprises a plurality of communication devices 106A-106N connected together via a communication network 103 (also referred to herein as a “network 103”). In a preferred embodiment of the present invention, one communication device 106A includes web server functionality, which allows the communication device 106A to provide a plurality of user interfaces to other communication devices 106B-106N. For example and not limitation, the user interfaces are provided by communication device 106A as web pages and other data formats to be displayed on a web browser residing on communication devices 106B-106N. Accordingly, the user interfaces provided by communication device 106A may permit the transfer of data between communication device 106A and the other communication devices 106B-106N. As described below, the user interfaces provided by communication device 106A facilitate communications between users (or participants) and high-profile individuals utilizing communication devices 106B-106N.

One skilled in the art will recognize that the network 103 typically contains the infrastructure and facilities appropriate to connect a group of two or more communication devices 106A-106N (including, without limitation, a plurality of computer systems in communication with each other). The network 103 and communication devices 106A-106N may be configured in multiple network topologies including, but not limited to, star, bus, or ring configurations. Also, the network 103 and communication devices 106A-106N may be broadly categorized as belonging to a particular architecture including, but not limited to, peer-to-peer or client/server architectures. The network 103 may additionally be classified by the geographical location of the communication devices 106A-106N and the types thereof. For example, if the network 103 connects a plurality of computer systems or servers located proximate to each other, such as within a building, the network 103 is referred to as a local-area network (LAN); if the computer systems are located farther apart, the network 103 is generally referred to as a wide-area network (WAN), such as the Internet; if the computer systems are located within a limited geographical area, such as a university campus or military establishment, the network 103 is referred to as a campus-area network (CAN); if the computer systems are connected together within a city or town, the network 103 is referred to as a metropolitan-area network (MAN); and if the computer systems are connected together within a user's home, the network 103 is referred to as a home-area network (HAN).

The number of communication devices 106A-106N within the high-profile individual communication system environment 100 may vary depending on the requirements of the high-profile individual communication system 300. Although FIG. 1 illustrates three communication devices 106A, 106B, 106N connected to the communication network 103, those skilled in the art will appreciate that any number of communication devices 106A-106N may be connected to the communication network 103 without departing from the scope of the present invention. In one embodiment of the present invention, the number of communication devices 106B-106N (e.g., client systems) corresponds to the number of subscribers (e.g., participants and high-profile individuals) of the high-profile individual communication system 300, which resides on a central communication device 106A (e.g., server system). Each communication device 106A-106N, through use of a network interface and other appropriate hardware and software components, connect to the network 103 for bidirectional communication of signals and data therewith and, therefore, connect communicatively to each other for the bidirectional communication of signals and data therewith.

One skilled in the art will recognize that the connecting of communication devices 106A-106N and network 103 may include or require any appropriate type of connection for bi-directional communication of signals and/or media including, but not limited to, analog, digital, wired and wireless communication channels. Such communication channels may utilize, but are not be limited to, copper wire, optical fiber, radio frequency, infrared, satellite, or other facilities and media.

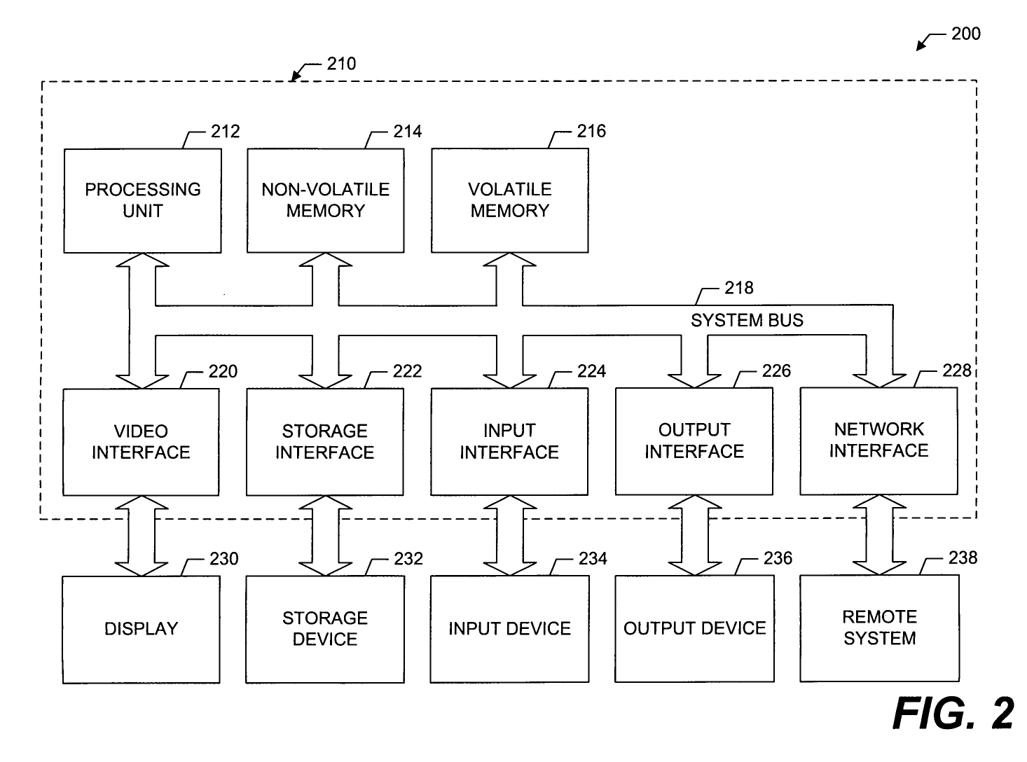

FIG. 2 displays a block diagram representation of a computing environment 200 which may be utilized in accordance with an exemplary embodiment of the present invention. Communication devices 106A-106N of the high-profile individual communication system environment 100 may include, but are not limited to, personal computers, mainframe computers, servers, hand-held or laptop devices, multiprocessor systems, microprocessor-based systems, set top boxes, programmable consumer electronics, network PCs, minicomputers, mainframe computers, distributed computing environments that include any of the above systems or devices, and the like. It should be understood, however, that the features and aspects of the exemplary embodiment of the present invention may be implemented by or into a variety of systems and system configurations and any examples provided within this description are for illustrative purposes only.

FIG. 2 and the following discussion provide a general overview of a platform onto which an embodiment of the present invention, or portions thereof, may be integrated, implemented and/or executed. Although reference has been made to instructions within a software program being executed by a processing unit, those skilled in the art will understand that at least some of the functions performed by the software may also be implemented by using hardware components, state machines, or a combination of any of these techniques. In addition, a software program which may implement an embodiment of the present invention may also run as a stand-alone program or as a software module, routine, or function call, operating in conjunction with an operating system, another program, system call, interrupt routine, library routine, or the like. The term program module is used herein to refer to software programs, routines, functions, macros, data, data structures, or any set of machine readable instructions or object code, or software instructions that may be compiled into such, and executed by a processing unit 212.

Those skilled in the art will appreciate that the computing environment 200 illustrated in FIG. 2 may take on many forms and may be directed towards performing a variety of functions. Generally, the computing environment 200 may be any system that includes a computer processor. Examples of such forms and functions may include, but are not limited to, personal computers, hand-held devices such as personal data assistants, note-book computers, lap-top computers, mainframe computers, servers and a variety of other applications, each of which may serve as an exemplary environment for embodiments of the present invention.

The exemplary computing device 210 (e.g., communication device 106) may comprise various components including, but not limited to, a processing unit 212, non-volatile memory 214, volatile memory 216, and a system bus 218 that couples the non-volatile memory 214 and volatile memory 216 to the processing unit 212. The non-volatile memory 214 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, battery backed random access memory (RAM), CDROM, digital versatile disks (DVD) or other optical disk storage, magnetic cassettes, magnetic tape, magneto-optical storage devices, magnetic disk storage or other magnetic storage devices, or any other medium which may be used to store the desired information. The non-volatile memory 214 may provide storage for power-on and reset routines (bootstrap routines) that are invoked upon applying power or resetting the computing device 210. In some configurations the non-volatile memory 214 may provide the basic input/output system (BIOS) routines that are utilized to perform the transfer of information between elements within the various components of the computing device 210.

The volatile memory 216 may include, but is not limited to, a variety of memory types and devices including, but not limited to, random access memory (RAM), dynamic random access memory (DRAM), synchronous dynamic random access memory (SDRAM), double data rate synchronous dynamic random access memory (DDR-SDRAM), bubble memory, registers, or the like. The volatile memory 216 may provide temporary storage for routines, modules, functions, macros, data, etc. that are being or may be executed by, or are being accessed or modified by, the processing unit 212.

In another embodiment, the non-volatile memory 214 and/or the volatile memory 216 may comprise a remote storage facility accessible through a wired and/or wireless network system. Additionally, the non-volatile memory 214 and/or the volatile memory 216 may comprise a memory system comprising a multi-stage system of primary and secondary memory devices, as described above. The primary memory device and secondary memory device may operate as a cache for the other or the second memory device may serve as a backup to the primary memory device. In yet another embodiment, the non-volatile memory 214 and/or the volatile memory 216 may comprise a memory device configured as a simple database file or as a searchable, relational database using a query language, such as SQL.

The computing device 210 may access one or more external display devices 230 such as a CRT monitor, LCD panel, LED panel, electro-luminescent panel, or other display device, for the purpose of providing information or computing results to a user. In some embodiments, the external display device 230 may actually be incorporated into the product itself. The processing unit 212 may interface to each display device 230 through a video interface 220 coupled to the processing unit 210 over the system bus 218.

The computing device 210 may send output information to the display 230 and to one or more output devices 236 such as a speaker, modem, printer, plotter, facsimile machine, RF or infrared transmitter, computer or any other of a variety of devices that may be controlled by the computing device 210. The processing unit 212 may interface to each output device 236 through an output interface 226 coupled to the processing unit 212 over the system bus 218.

The computing device 210 may receive input or commands from one or more input devices 234 such as, but not limited to, a keyboard, pointing device, mouse, modem, RF or infrared receiver, microphone, joystick, track ball, light pen, game pad, scanner, camera, computer or the like. The processing unit 212 may interface to each input device 234 through an input interface 224 coupled to the processing unit 212 over the system bus 218.

It will be appreciated that program modules implementing various embodiments of the present invention may be stored in the non-volatile memory 214, the volatile memory 216, or in a remote memory storage device accessible through the output interface 226 and the input interface 224. The program modules may include an operating system, application programs, other program modules, and program data. The processing unit 212 may access various portions of the program modules in response to the various instructions contained therein, as well as under the direction of events occurring or being received over the input interface 224.

The computing device 210 may provide data to and receive data from one or more other storage devices 232, which may provide volatile or non-volatile memory for storage and which may be accessed by computing device 210. The processing unit 212 may interface to each storage device 232 through a storage interface 222 over the system bus 218.

The interfaces 220, 222, 224, 226, and 228 may include one or more of a variety of interfaces, including but not limited to, cable modems, DSL, T1, T3, optical carrier (e.g., OC-3), V series modems, an RS-232 serial port interface or other serial port interface, a parallel port interface, a universal serial bus (USB), a general purpose interface bus (GPIB), an optical interface such as infrared or IrDA, an RF or wireless interface such as Bluetooth, or other interface.

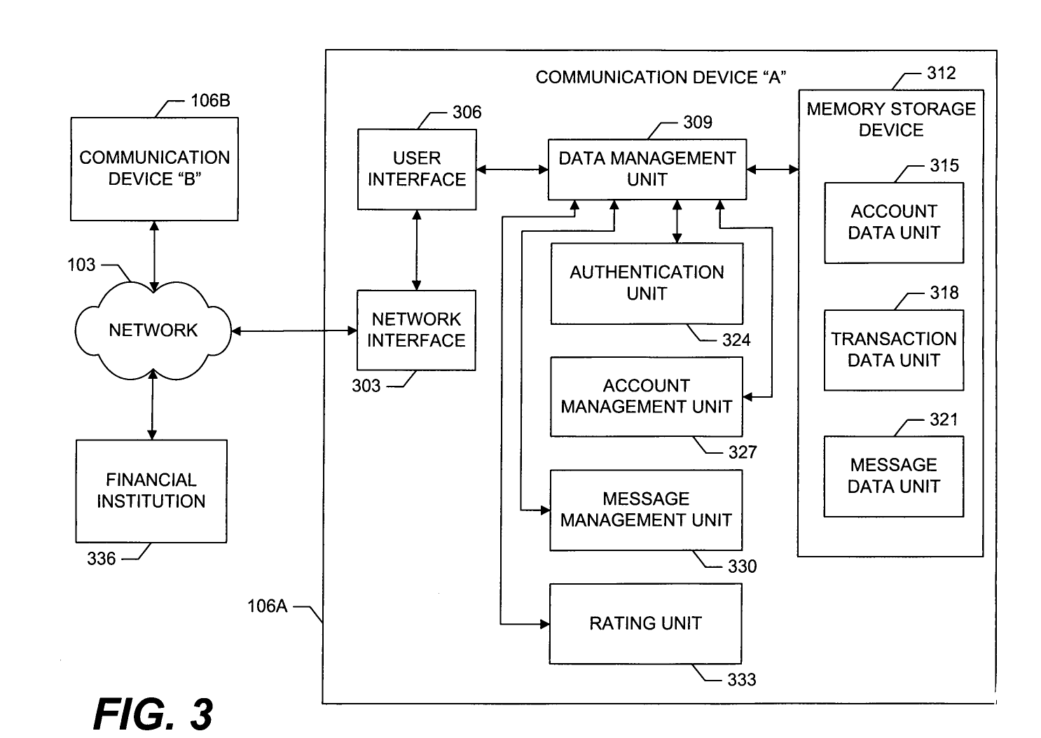

FIG. 3 displays a block diagram representation of a high-profile individual communication system 300 in accordance with some embodiments of the present invention. The high-profile individual communication system 300 is configured with hardware and/or software appropriate to perform tasks and provide capabilities and functionality as described herein. In operation, the high-profile individual communication system 300 provides subscription accounts to high-profile individuals and participants, whereby a participant attempts to communicate with a high-profile individual (also referred to as a famous or notable person) by submitting a communication (e.g., e-mail) and an offer amount. A high-profile individual includes, but is not limited to, authors, actors, actresses, artists, politicians, business celebrities, sport celebrities, musicians, radio celebrities, individuals who make the news, and any other individuals who participants wish to communication with, but would not normally have access to. The communication and offer amount are provided to the high-profile individual without any obligation to respond. If a high-profile individual does respond to the communication of the participant, then the high-profile individual communication system 300 receives payment equal to the offer amount from the participant prior to providing the response to the participant. The high-profile individual communication system 300 then provides the high-profile individual with a predetermined percentage of the received offer amount. A second predetermined percentage of the received offer amount may also be provided to organizations, sponsors, charities, companies, or other individuals (such as the company or organization the high-profile individual is affiliated with). Alternatively, the high-profile individual can designate that the predetermined percentage be provided to a third-party (e.g., a charity or non-profit organization), if so desired by the high-profile individual.

After receiving the response, the participant may rate and comment on the response, where the rating and comment are displayed to other participants to assist in determining how much to offer for a response from the particular high-profile individual. A high-profile individual with a low rating or unfavorable comments will likely receive lower offer amounts than a high-profile individual with a high rating or more favorable comments.

The high-profile individual communication system 300 includes a communication device 106A adapted to manage communications between participants and high-profile individuals. The communication device 106A comprises a network interface 303, a user interface 306, a data management unit 309, an authentication unit 324, an account management unit 327, a message management unit 330, a rating unit 333, and a memory storage device 312. The memory storage device 312 may comprise an account data unit 315, a transaction data unit 318, and a message data unit 321.

The network interface 303 is typically a hardware device, such as a network interface card or an expansion card of the communication device 106A, which facilitates connectivity between the communication device 106A and the network 103. Although not shown in FIG. 3, the network interface 303 may comprise a radio transmitter and receiver which enable wireless communication between the communication device 106A and an access point (not shown) of the network 103. The network interface 303 is adapted to receive data from other communication devices 106B-106N via network 103 and provide the received data to the data management unit 309.

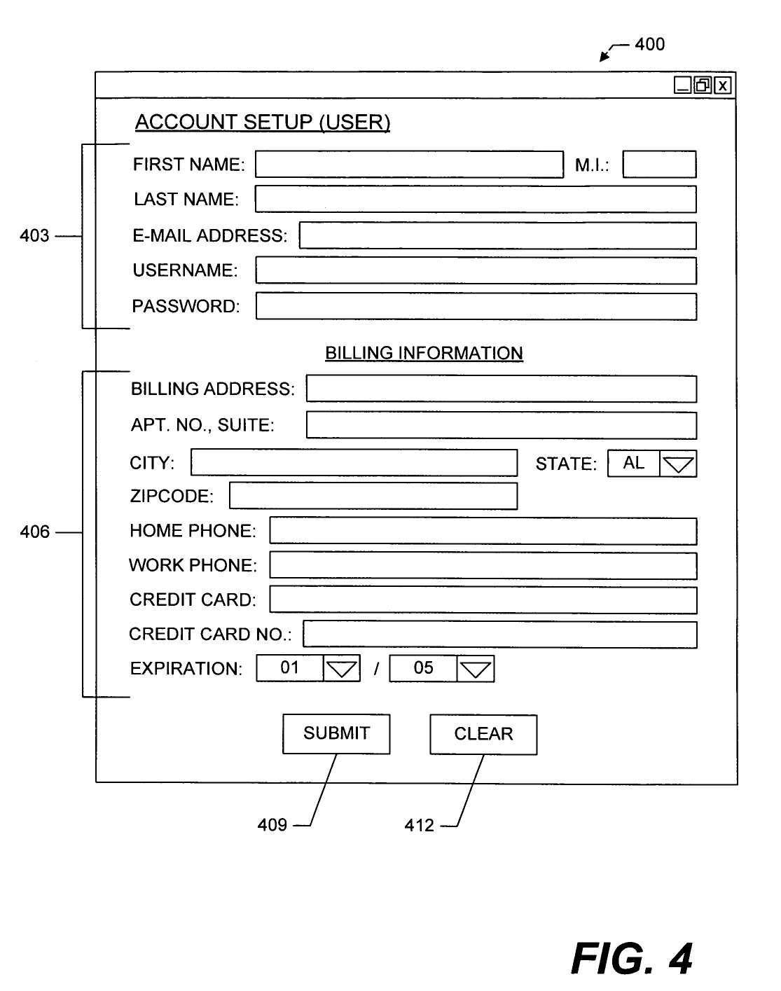

Generally, data is provided to and received from the other communication devices 106B-106N through a user interface 306. The user interface 306 provides a participant or high-profile individual with an interface to partake in account registration, account management, subscriber authentication, and communication management (e.g., sending and receiving e-mail, audio, or video to and from other subscribers). One skilled in the art will recognize that the user interface 306 may be configured in a variety of formats and may comprise programming, program modules, or machine instructions for the transferring of data between communication device 106A and other communication devices 106B-106N. Exemplary formats of the user interface 306 are described more fully below with reference to FIGS. 4-13.

The data management unit 309 receives and processes all data received from network interface 303 and user interface 306 (e.g., data received from other communication devices 106B-106N). Depending on the type of data received, the data management unit 309 may provide the data to the memory storage device 312 for storage or to the authentication unit 324, the account management unit 327, the message management unit 330, and/or the rating unit 333 for further processing. The data management unit 309 may initially provide a general user interface 306 to any communication device 106B-106N that accesses the high-profile individual communication system 300. The general user interface 306 provides a user with a variety of options including, but not limited to, registering for a participant account, registering for a high-profile individual account, logging into an already existing account, searching through a plurality of profiles (e.g., biographical information) of high-profile individuals, and requesting that a high-profile individual create a profile. While any user may browse through the plurality of profiles of high-profile individuals, only registered participants may actually submit communications to a high-profile individual.

If a user selects the option of registering for a participant account, a request is transmitted from the communication device 106B-106N to the data management unit 309 of the high-profile individual communication system 300. Upon processing the request, the data management unit 309 provides the user with a user account registration interface 306, 400, which requires the user to provide user account data to the data management unit 309. The data management unit 309 provides the received user account data to the account management unit 327. If the account management unit 327 validates the user account data, then the account management unit 327 creates a unique account for the user (now participant), whereby the account data is stored in the account data unit 315 of the memory storage device 312.

If a high-profile individual selects the option of registering for a high-profile individual account, a request is transmitted from the communication device 106B-106N to the data management unit 309 of the high-profile individual communication system 300. Upon processing the request, the data management unit 309 provides the high-profile individual with a high-profile individual account registration interface 306, 500, which requires the high-profile individual to provide high-profile individual account data to the data management unit 309. The data management unit 309 provides the received high-profile individual account data to the account management unit 327. If the account management unit 327 validates the high-profile individual account data, then the account management unit 327 creates a unique account for the high-profile individual, whereby the account data is stored in the account data unit 315 of the memory storage device 312.

If a user (e.g., a participant or a high-profile individual) selects the option of logging into an already existing account, a request is transmitted from the communication device 106B-106N to the data management unit 309 of the high-profile individual communication system 300. Upon processing the request, the data management unit 309 provides the user with a login interface 306, which requires the user to provide authentication data (e.g., username and password) to the data management unit 309. The data management unit 309 provides the received authentication data to the authentication unit 324. The authentication unit 324 determines whether the received authentication data corresponds to authorization data (e.g., previously submitted username and password) associated with a preexisting account stored on the memory storage device 312. If the authentication unit 324 validates the received authentication data, then, depending on the type of account, the data management unit 309 permits the user to access certain user interfaces 306 such as a user communication interface 800, a high-profile individual communication selection interface 900, a high-profile individual communication interface 1000, a user communication display and rating interface 1100, and a high-profile individual communication block interface 1200.

If a user selects the option of searching through a plurality of profiles of high-profile individuals, a request is transmitted from the communication device 106B-106N to the data management unit 309 of the high-profile individual communication system 300. Upon processing the request, the data management unit 309 provides the user with a high-profile individual search interface 306, 600, which permits a user to search for a particular high-profile individual or search through a variety of categories of high-profile individuals. Unregistered users may search through the profiles of high-profile individuals, but only registered users may send a communication to a particular high-profile individual. If a user selects a particular high-profile individual from a list of profiles of high-profile individuals, then the data management unit 309 provides the selection to the account management unit 327, which pulls the corresponding profile from the account data unit 315 of the memory storage device 312. The account management unit 327 then provides the retrieved profile to the user by means of a high-profile individual biographical profile interface 306, 700. In addition to providing biographical data about a particular high-profile individual, the high-profile individual biographical profile interface 306, 700 also provides a list of participants that have sent a communication and offer amount to the high-profile individual (e.g., the list of participants may be ordered by offer amount or any other appropriate ordering scheme); a high-profile individual response rating (calculated from ratings provided by participants that have received responses from the high-profile individual) and/or user-submitted comment; and an option to communicate with the high-profile individual. Only registered participants may choose the option to communicate with the high-profile individual.

If a registered user (e.g., participant) selects the option to communicate with the high-profile individual, a request is transmitted from the communication device 106B-106N to the data management unit 309 of the high-profile individual communication system 300. Upon processing the request, the data management unit 309 provides the registered user with a user communication interface 306, 800, which permits a registered user to submit a message (e.g., communication) and offer amount to the high-profile individual via the data management unit 309. The data management unit 309 provides the submitted message and offer amount to the message management unit 330 which stores the message and offer amount associated with the user in the message data unit 321 of the memory storage unit 312. The message management unit 330 also associates the message and offer amount with the account of the high-profile individual, so that the high-profile individual may be given the message and offer amount via a high-profile individual communication selection interface 306, 900. During account registration, the registered user provides a payment method (e.g., a credit card number or online payment service) to pay for a response from the high-profile individual. The registered user, however, is not charged for submitting a message and offer amount to the high-profile individual at this time. The registered user is only charged if the high-profile individual responds to the submitted message (e.g., communication).

When a high-profile individual successfully logs into the high-profile individual communication system 300, the data management unit 309 provides the high-profile individual with a high-profile individual communication selection interface 306, 900. The high-profile individual communication selection interface 306, 900 provides the high-profile individual with a list of submitted communications (e.g., messages and offer amounts) from a variety of registered users (e.g., participants). The order of the list of submitted communications may be by offer amount, date, or any other appropriate ordering scheme. Additionally, the high-profile individual communication selection interface 900 provides the options of deleting communications, blocking participants, and selecting communications for viewing. If the high-profile individual selects the option to delete a communication without responding to it, the communication is removed from the list of communications and the data management unit 309 notifies the registered user that submitted the communication (e.g., the message management unit 330 associates a message with the registered user's account or an e-mail is sent to a user submitted e-mail address) that the high-profile individual has decided not to respond to the submitted communication. If the high-profile individual selects the option of blocking a participant, the data management unit 309 provides the high-profile individual with a high-profile individual communication block interface 306, 1200, which allows the high-profile individual to refuse communications from a particular participant. To block a participant, the account management unit 327 stores the name of the blocked participant with the account data of the high-profile individual located in the account data unit 315 of the memory storage device 312. When a blocked participant submits a communication to the high-profile individual, the message management unit 330 checks to see if the high-profile individual allows communication from the participant. If not, the data management unit 309 refuses the communication (e.g., it is not stored in the memory storage device 312 and, therefore, not provided to the high-profile individual) and a denial notification is provided to the blocked participant or user.

If the high-profile individual selects the option of viewing a communication, the message management unit 330 provides the high-profile individual with a high-profile individual communication interface 306, 1000, which includes the communication and offer amount from the participant, as well as options for replying to the communication. If a high-profile individual selects the option of replying to the communication, the high-profile individual communication interface 306, 1000 permits the high-profile individual to submit a reply to the communication. Upon receiving a response to a communication from the high-profile individual, the data management unit 309 receives payment of the offer amount from the participant (e.g., by the designated payment method, such as through financial institution 336), stores a payment record in the transaction data unit 318 of the memory storage unit 312, and provides the response to the message management unit 330 (but only after receiving payment). The message management unit 330 provides the response to the message data unit 321 of the memory storage device 312 for storage. The response is associated with the account data of the particular participant or user, so that the participant may access the response upon logging onto the high-profile individual communication system 300. The user may be notified by voicemail or e-mail that a response from the high-profile individual has been received. Alternatively, the actual response is e-mailed to a submitted e-mail address previously provided by the participant. Subsequently, the data management unit 309 provides a predetermined percentage of the received offer amount to the high-profile individual through a predetermined payment method and stores a payment record in the transaction data unit 318 of the memory storage device 312.

The predetermined percentage of the received offer amount may be held for a predetermined period of time prior to providing the received amount to the high-profile individual. This predetermined period of time ensures that the response of the high-profile individual is acceptable prior to payment to the high-profile individual.

A participant may view the response from a high-profile individual upon logging onto the high-profile individual communication system 300, whereby the message management unit 330 provides the participant with a user communication display and rating interface 306, 1100. The user communication display and rating interface 306, 1100 provides the participant with the response from the high-profile individual and the option of rating or commenting on the response from the high-profile individual (e.g., a rating from 1 to 10, where 10 is the highest rating). One skilled in the art will recognize that a variety of rating schemes exist and may be appropriate for the purposes of the present invention. Upon receiving a rating and/or comment from the participant that received the response from the high-profile individual, the data management unit 309 provides the rating and/or comment to the rating unit 333, which combines the new rating and/or comment with the previously recorded ratings stored and comments with the account data of the high-profile individual. The rating unit 333 then stores the comment and newly calculated rating with the account data of the high-profile individual located in the account data unit 315 of the memory storage device 312.

If a user (registered or unregistered) selects the option to request that a high-profile individual create a profile on the high-profile individual communication system 300, a request is transmitted from the communication device 106B-106N to the data management unit 309 of the high-profile individual communication system 300. Upon receiving the request the data management unit 309 stores the request in the memory storage device 312. If a predetermined level of interest for a particular high-profile individual exists, the high-profile individual communication system may submit an invitation to the high-profile individual to create an account (e.g., register) on the high-profile individual communication system 300.

In an alternative embodiment of the present invention, communications from the participant and responses from the high-profile individual are not stored within the high-profile individual communication system 300. Instead, all communications and responses are sent through the high-profile individual communication system 300, recorded by the data management unit 309, and then forwarded to the submitted e-mail addresses of the participant or high-profile individual, as the case may be. The true e-mail addresses of the participants and high-profile individuals are not disclosed or provided. Accordingly, several of the user interfaces 306 described herein would be unnecessary. The data management unit 309 would merely forward communications, receive payments of the offer amount, forward responses, and provide payment of a predetermined percentage of the received offer amount.

One skilled in the art will recognize that the memory storage device 312, including the account data unit 315, the transaction data unit 318, and the message data unit 321, may include a memory device capable of storing and retrieving data including, but not limited to, volatile and/or non-volatile memory.

FIG. 4 displays a pictorial representation of a user account registration interface 400 in accordance with some embodiments of the present invention. When a user requests to register with the high-profile individual communication system 300, the data management unit 309 provides the user with a user account registration interface 400. The user account registration interface 400 includes personal data fields 403, payment data fields 406, a submit button 409, and a clear button 412. When engaged the submit button 409 provides all entered data within the personal data fields 403 and the payment data fields 406 to the data management unit 309. The clear button 412, when engaged, clears the personal data fields 403 and the payment data fields 406 of any data entered within said fields. The personal data fields 403 may include, but are not limited to, first name, middle initial, last name, e-mail address, username, and password. The payment data fields 406 may include, but are not limited to, billing address, apartment or suite number, city, state, zip code, home phone number, work phone number, credit card type, credit card number, and expiration date of the credit card. As described above, the account management unit 327 validates the received personal data and payment data, and then creates an account by saving the personal data and payment data in the account data unit 315 of the memory storage device 312.

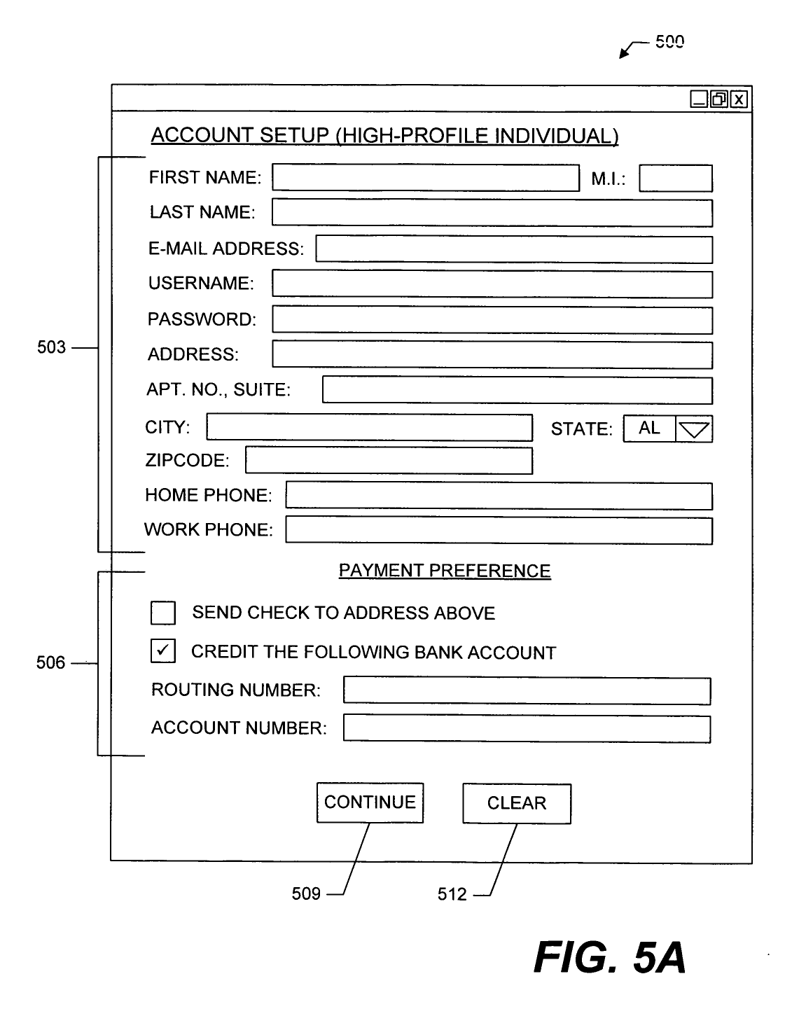

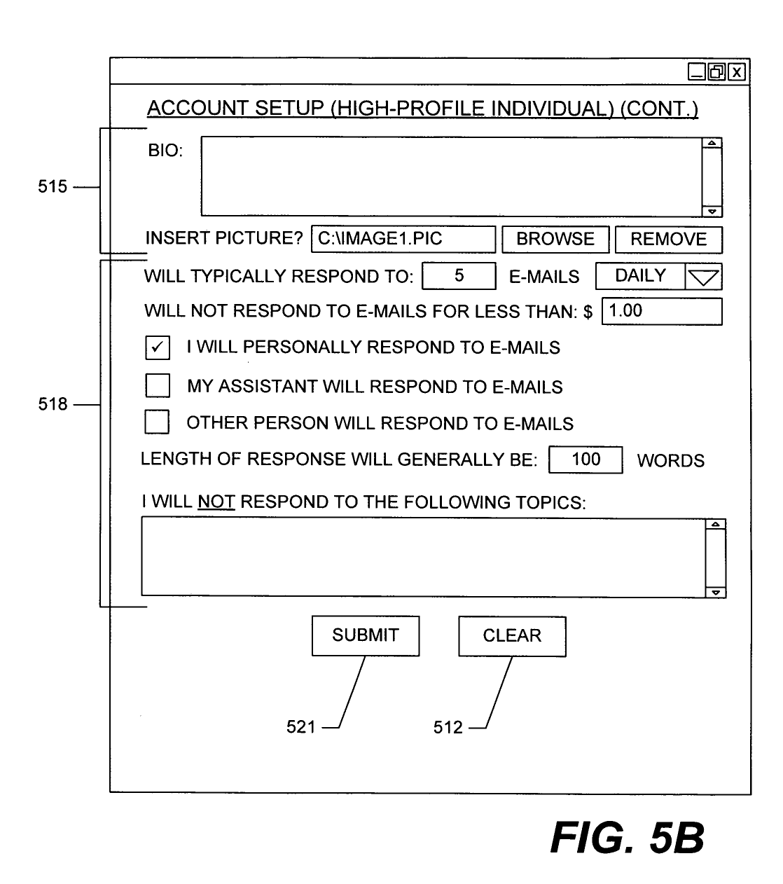

FIGS. 5A-5B, collectively known as FIG. 5, display a pictorial representation of a high-profile individual account registration interface 500 in accordance with some embodiments of the present invention. When a high-profile individual requests to register with the high-profile individual communication system 300, the data management unit 309 provides the high-profile individual with a high-profile individual account registration interface 500. The high-profile individual account registration interface 500 includes personal data fields 503, payment preference data fields 506, a continue button 509, a submit button 521, a clear button 512, a biographical description field 515 (including text and graphics), and response description fields 518. When engaged the continue button 509 provides the second portion of the high-profile individual account registration interface 500 to the high-profile individual. When engaged the submit button 521 provides all entered data within all of the described fields to the data management unit 309. The clear button 512, when engaged, clears all the data within all of the described fields of the particular portion of the high-profile individual account registration interface 500. The personal data fields 503 may include, but are not limited to, first name, middle initial, last name, e-mail address, username, password, address, apartment or suite number, city, state, zip code, home phone number, and work phone number. The payment preference data fields 506 may include, but are not limited to, payment preference between a mailed check and direct deposit, direct deposit routing number, and direct deposit account number. The biographical description field 515 may include, but is not limited to, biographical text and a digital photograph.

The response description fields 518 may include, but are not limited to, the number of responses typically made in a given time period, the minimum offer amount that will be accepted, an indication whether the high-profile individual, an assistant, or other individual (e.g., relative or friend, etc.) will be responding to all communications, the general length of a response, and a list of topics that are impermissible for communication. To ensure that high-profile individual conforms his or her response as specified through the response description fields 518, each high-profile individual may enter into a contractual agreement (not shown) that requires the high-profile individual to meet the specifications of the response in order to receive the predetermined percentage of the received offer amount (e.g., must create an adequate response as a prerequisite of being paid for the response). Further, the high-profile individual communication system 300 can include an authentication system adapted to authenticate that the high-profile individuals is indeed who he or she claims to be. Such an authentication system will ensure that other users and participants of the high-profile individual communication system 300 are actually communicating with the genuine high-profile individual. The authentication system can include, but is not limited to, having the high-profile individual provide particular personal information that can be easily verified, having the high-profile individual provide proof of identity (such as by providing a copy of a driver's license, credit card information, or verification from the organization or company that the high-profile individual is associated with), obtaining biometrics from the high-profile individual, or other appropriate authentication methods.

The high-profile individual account registration interface 500 may also provide the high-profile individual with the ability to designate the frequency in which the high-profile individual checks messages, the number of communications to be displayed at any given time to the high-profile individual (e.g., the top hundred communications based on offer amount). As described above, the account management unit 327 validates all of the received data, and then creates an account by saving the received data in the account data unit 315 of the memory storage device 312.

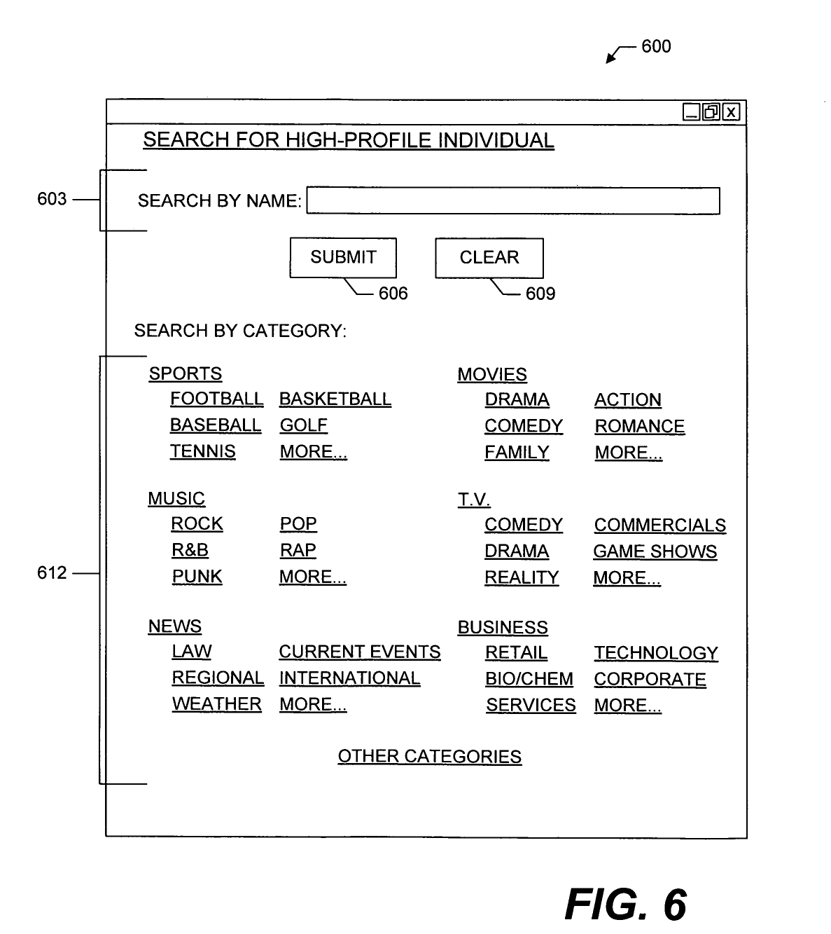

FIG. 6 displays a pictorial representation of a high-profile individual search interface 600 in accordance with some embodiments of the present invention. When a user selects the option of searching through profiles of high-profile individuals, the data management unit 309 provides the user with a high-profile individual search interface 600. The high-profile individual search interface 600 permits the user to search directly for a particular high-profile individual or indirectly by perusing categories of high-profile individuals. The high-profile individual search interface 600 includes a high-profile individual name search field 603, a submit button 606, a clear button 609, and a list of categories associated with high-profile individuals 612. The high-profile individual name search field 603 accepts the name of a high-profile individual to be searched within the account data unit 315 of the memory storage device 312. When engaged the submit button 606 provides the data entered into the high-profile individual name search field 603 to the data management unit 309. The clear button 609, when engaged, clears all of the data out of the high-profile individual name search field 603. The list of categories associated with high-profile individuals 612 may include sub-categories and are selectable options for a user to view high-profile individual profiles within a selected category. The list of categories associated with high-profile individuals 612 may include, but is not limited to, the categories of sports, movies, music, television, news, business, and other appropriate categories, such as an alphabetical list of high-profile individuals' last names. The sports category may include, but is not limited to, the categories of football, basketball, baseball, golf, tennis, and any other appropriate sport category. The movies category may include, but is not limited to, the categories of drama, action, comedy, romance, family, and any other appropriate movies category. The music category may include, but is not limited to, the categories of rock, pop, rhythm and blues, rap, punk, and any other appropriate music category. The television category may include, but is not limited to, the categories of comedy, commercials, drama, game shows, reality shows, and any other appropriate television categories. The news category may include, but is not limited to, the categories of law, current events, regional, international, weather, and any other appropriate news category. The business category may include, but is not limited to, the categories of retail, technology, biological and chemical, corporate, services, and any other appropriate business category. Each high-profile individual account may be categorized within the aforementioned categories, whereby the appropriate categories are associated with the account data of the high-profile individual stored in the account data unit 315 of the memory storage device 312. As described above, the account management unit 327 receives the selection from a user of a profile of a particular high-profile individual and provides the user with the high-profile individual biographical profile interface 700.

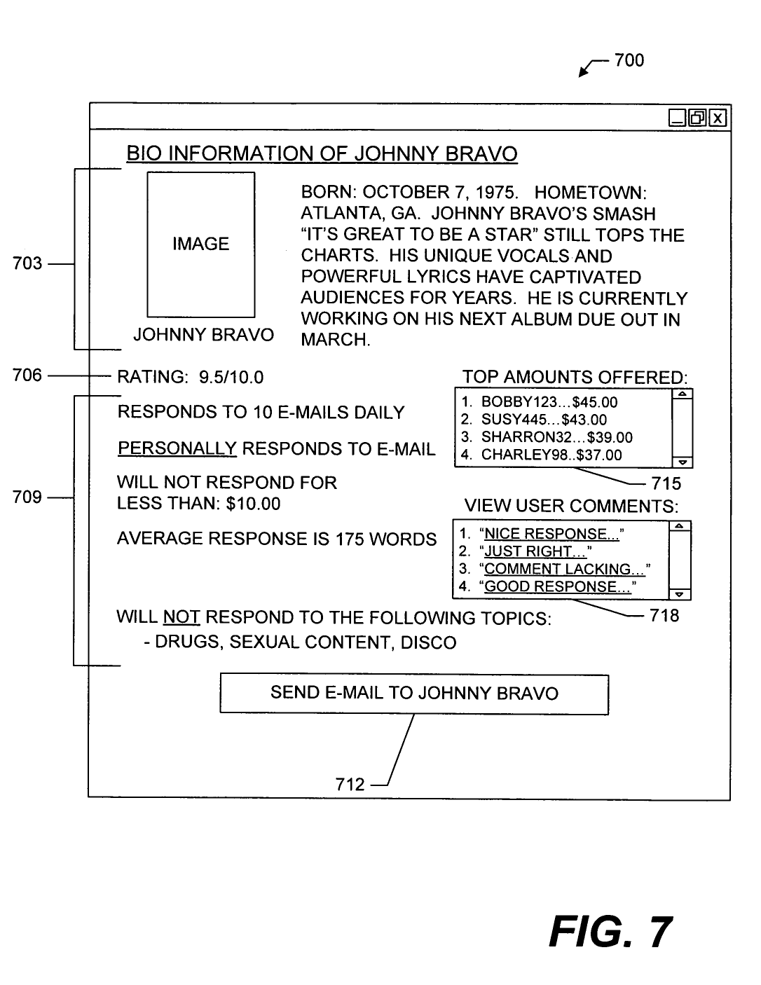

FIG. 7 displays a pictorial representation of a high-profile individual biographical profile interface 700 in accordance with some embodiments of the present invention. When a user selects a profile of a high-profile individual for viewing, the account management unit 327 provides the user with the high-profile individual biographical profile interface 700. The high-profile individual biographical profile interface 700 includes biographical description data (submitted via the biographical description field 515 of the high-profile individual account registration interface 500), a high-profile individual response rating 706, response description data 709 (submitted via the response description fields 518 of the high-profile individual account registration interface 500), a list of top offers from users 715, a list of user comments 718 describing the quality of responses made by the high-profile individual, and an option to send a communication to the high-profile individual 712. The high-profile individual response rating 706 is calculated by the rating unit 333 every time a rating is received from a participant regarding the response of the high-profile individual. The rating informs the participant of the quality of the responses received from the high-profile individual and, therefore, will affect the offer amount submitted by a participant.

The list of top offers from users 715 includes a subset of the highest offers from participants that have submitted communications to the high-profile individual. The list of top offers from users 715 informs participants of a range of offer amounts, so that the participant may make a decision on how likely an offer amount will entice a response from the high-profile individual. Although high-profile individuals are under no obligation to respond to a communication, the higher offer amounts are typically more likely to receive a response. Indeed, the high-profile individual is not required to respond to any communications received from participants, but will only receive payment for the responses he or she provides.

The list of user comments 718 includes links to user comments describing the quality of responses received from the high-profile individual. The list of user comments 718 informs participants of the quality of responses provided by the high-profile individual, and, therefore, will affect the offer amount submitted by a participant.

Only registered users (e.g., participants) may select the option to send a communication to the high-profile individual 712, whereby the data management unit 309 provides the registered user with a user communication interface 800.

In an alternative embodiment, the high-profile individual communication system 300 provides auction capabilities in order to auction products or items of the high-profile individual (such as, but not limited to, autographed memorabilia) to users or participants. Users can submit auction bids for each item provided for auction. After a predetermined period of time, the auction ends and the product or item is awarded to the user with the highest bidder after payment has been received.

Further, the high-profile individual communication system 300 may provide links to a store or retailer that sells products relating to the high-profile individual (such as, but not limited to, collectibles relating to the high-profile individual). Unlike an auction, the user can purchase products at a set price, as the user would at traditional stores or retailers.

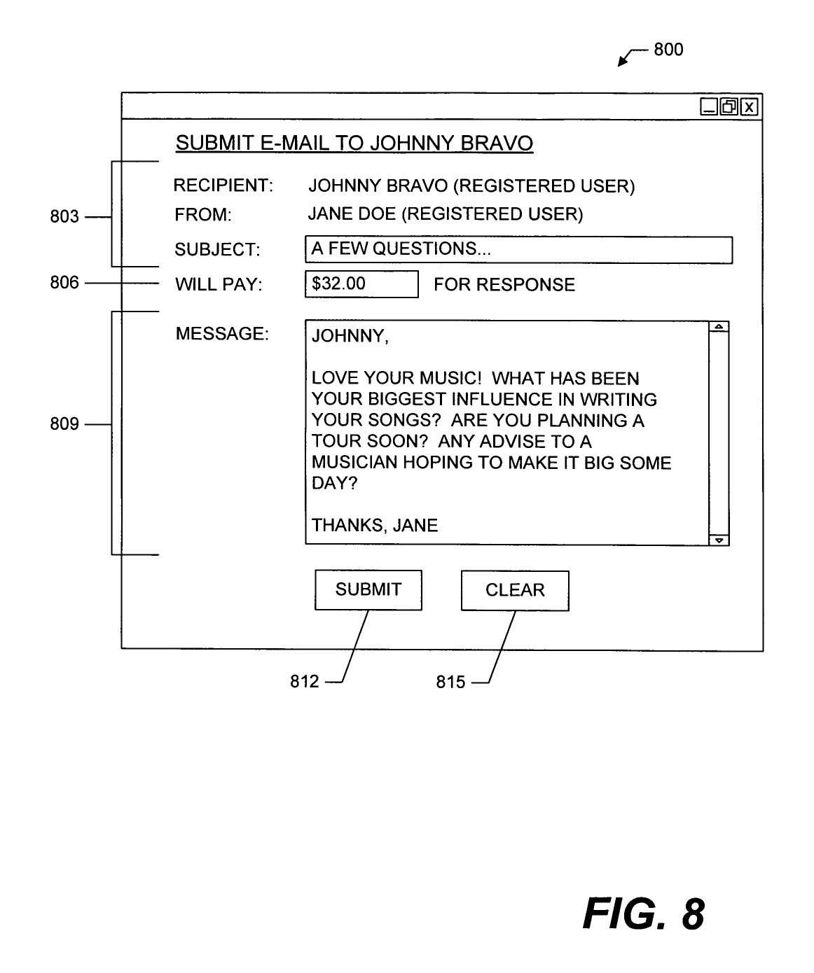

FIG. 8 displays a pictorial representation of a user communication interface 800 in accordance with some embodiments of the present invention. The data management unit 309 provides a user communication interface 800 to a registered user that has selected the option to send a communication to a high-profile individual 712. The user communication interface 800 includes communication header information 803, an offer amount field 806, a communication message field 809, a submit button 812, and a clear button 815. The communication header information 803 may include, but is not limited to, a recipient identifier (e.g., e-mail address or alias address of the high-profile individual), a sender identifier (e.g., e-mail address or alias address of the participant sending the communication), and a subject line field. The offer amount field 806 simply permits the participant to enter the amount he or she is willing to pay for a response from the high-profile individual. The communication message field 809 permits the participant to enter a message of a predetermined size that may be sent to the high-profile individual. When engaged, the submit button 812 provides all submitted data to the data management unit 309. The clear button 815, when engaged, removes all data entered into all of the data fields of the user communication interface 800. Upon receiving the submitted data, the data management unit 309 provides the communication and offer amount to the message management unit 330, which provides the communication and offer amount to the high-profile individual (e.g., associates the communication with the account of the high-profile individual) and stores the communication in the message data unit 321 of the memory storage device 312.

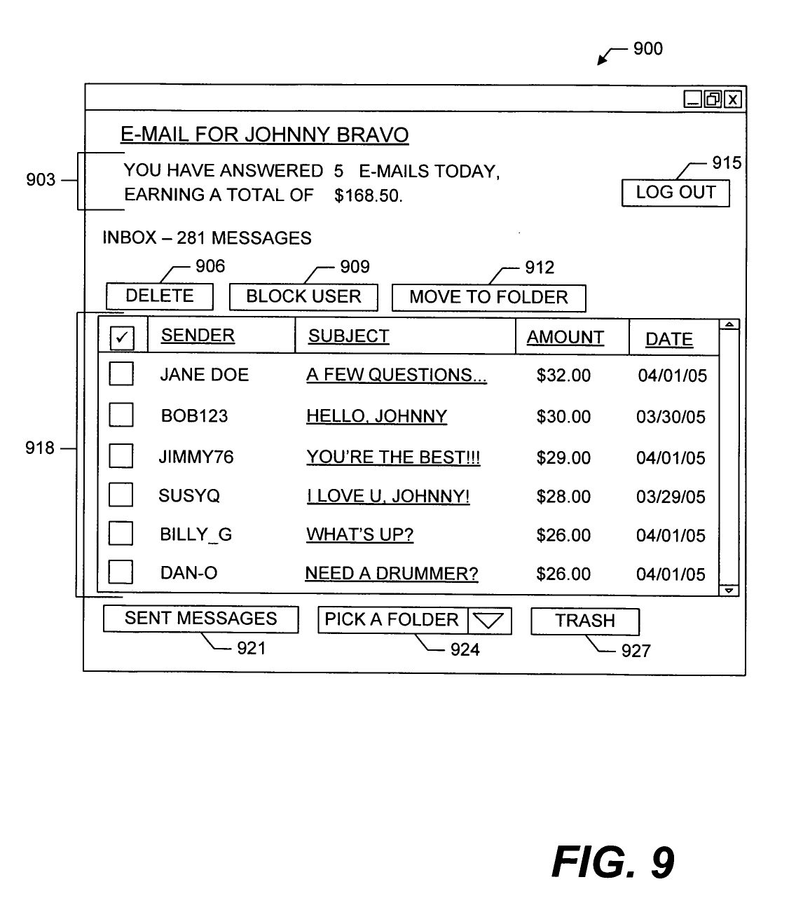

FIG. 9 displays a pictorial representation of a high-profile individual communication selection interface 900 in accordance with some embodiments of the present invention. The data management unit 309 provides a high-profile individual with a high-profile individual communication selection interface 900 including a list of the communications sent to the high-profile individual from participants. The high-profile individual communication selection interface 900 may include, but is not limited to, a response summary 903, a delete communication option 906, a block participant option 909, a move communication to a folder option 912, a log out option 915, a list of communications and offer amounts from participants 918, a sent messages option 921, a pick a folder option 924, and a trash option 927. The response summary 903 may include, but is not limited to, the number of responses made and the amount earned from the current login session. The response summary 903 allows the high-profile individual to keep track of the number of responses he or she has made and the amount he or she has earned by responding to the communications. The delete communication option 906, when engaged, deletes all selected communications from the list of communications and offer amounts 918, whether the high-profile individual has responded to the communication or not. Generally, when the high-profile individual responds to a communication, the corresponding entry within the list of communications and offer amounts 918 is designated as being responded to. The high-profile individual personally determines which communications to reply to and, therefore, submitting a communication with the highest offer does not necessarily guarantee that the high-profile individual will respond the communication. Although, a higher offer amount typically increases the likelihood that the high-profile individual will, in fact, respond to the communication. The block user option 909, when engaged, notifies the data management unit 309 that the selected participants should not be able to send communications to the high-profile individual. The account management unit 327 stores the list of blocked participants with the account data of the high-profile individual, whereby the list of blocked participants is checked every time a participant attempts to send a communication to the high-profile individual. A communication from a blocked participant will be refused by the data management unit 309. The move communication to a folder option 912, when engaged, moves all selected communications to a designated folder (e.g., previously created by the high-profile individual). The log out option 915, when engaged, will log the high-profile individual out of the current session, which will require the high-profile individual to subsequently log back into the high-profile individual communication system 300. The list of communications and offer amounts 918 may include, but is not limited to, the name or alias of the participant that sent the communication, the subject of the communication, the offer amount, and the date the communication was received. A high-profile individual may be provided with a predetermined number of communications (e.g., the top one-hundred, based on offer amount) and, therefore, a submitted communication and offer amount may not be received or considered by the high-profile individual. The sent messages option 921, when engaged, provides the high-profile individual with a list of responses created by the high-profile individual. The pick a folder option 924, when engaged, will provide the high-profile individual with a list of all communications that have been moved to the selected folder. The trash option 927, when engaged, will provide the high-profile individual with a list of all communications that have been deleted by the high-profile individual. If the high-profile individual selects the subject of a communication, the message management unit 330 provides the high-profile individual with the high-profile individual communication interface 1000, which allows the high-profile individual to read the communication and respond, if so desired.

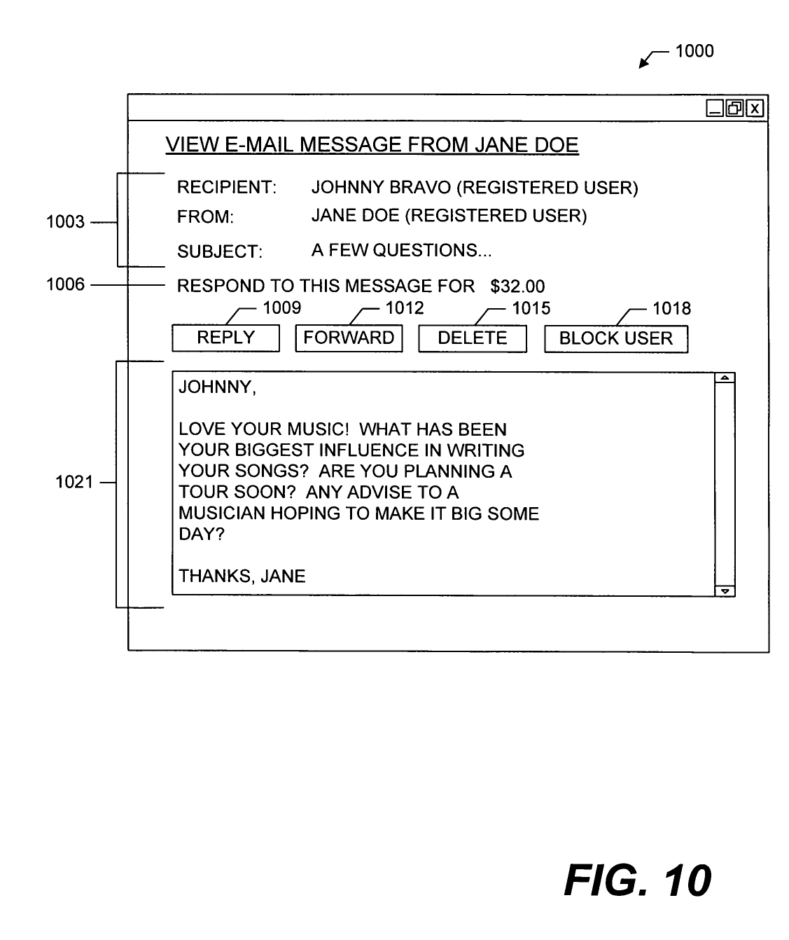

FIG. 10 displays a pictorial representation of a high-profile individual communication interface 1000 in accordance with some embodiments of the present invention. The message management unit 330 provides the high-profile individual with a high-profile individual communication interface 1000, when the high-profile individual selects a communication to view from a list of communications and offer amounts 918. The high-profile individual communication interface 1000 includes communication header information 1003, an offer amount 1006 (submitted in the offer amount field 806 of the user communication interface 800), a communication reply option 1009, a communication forward option 1012, a communication delete option 1015, a block user option 1018, and a communication message 1021. The communication header information 1003 may include, but is not limited to, a recipient identifier (e.g., e-mail address or alias address of the high-profile individual), a sender identifier (e.g., e-mail address or alias address of the participant sending the communication), and a subject line of the communication. The offer amount 1006 informs the high-profile individual how much the participant is willing to pay for a response to the communication. The communication reply option 1009, when engaged, permits the high-profile individual to include a response above the communication message 1021 and submit the response by selecting a submit button (not shown). The communication forward option 1012 allows the high-profile individual to forward the communication to a third-party. If the high-profile individual forwards the communication back to the participant that submitted the communication, then the forward may be considered a response by the high-profile individual. The communication delete option 1015, when engaged, removes the communication from the list of communications and offer amounts 918 and returns the high-profile individual to the high-profile individual communication selection interface 900. The block user option 1018, when engaged, notifies the data management unit 309 that the participant that provided the communication should not be able to send future communications to the high-profile individual. When the data management unit 309 receives a response from the high-profile individual, the data management unit 309 retrieves the offer amount from the participant, provides the response to the message management unit 330, and provides a predetermined percentage of the offer amount to the high-profile individual. The message management unit 330 provides the response to the participant via the user communication display and rating interface 1100, after storing the data in the message storage unit 321 of the memory storage device 312.

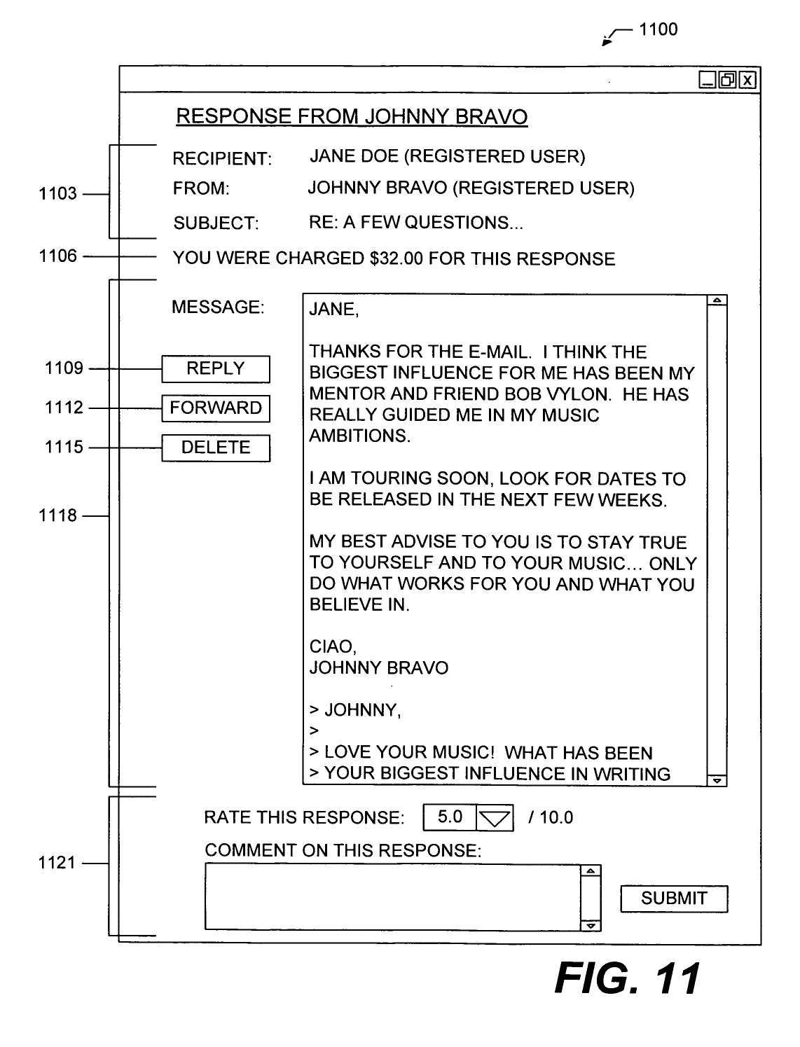

FIG. 11 displays a pictorial representation of a user communication display and rating interface 1100 in accordance with some embodiments of the present invention. The message management unit 330 provides a participant with a user communication display and rating interface 1100 after the high-profile individual responds to the communication submitted by the participant. The user communication display and rating interface 1100 includes response header information 1103, a payment notification 1106, a response replay option 1109, a response forward option 1112, a response delete option 1115, a response message 1118, and a response rating and comment option 1121. The response header information 1103 may include, but is not limited to, a recipient identifier (e.g., e-mail address or alias address of the participant), a sender identifier (e.g., e-mail address or alias address of the high-profile individual sending the response), and a subject line of the response. The payment notification 1106 informs the participant that he or she has been charged the offer amount as agreed upon for a response from the high-profile individual. The response reply option 1109, when engaged, provides the participant with the user communication interface 800, where the participant may send another communication and offer amount with reference to the response received from the high-profile individual. The response forward option 1112, when engaged, permits the participant to forward the response to a third-party, but not back to the high-profile individual (a new communication and offer amount must be made). The response delete option 1115 removes the response from the participant's account. The response message 1118 simply displays the response from the high-profile individual of the original communication submitted by the participant. The response rating and comment option 1121, when engaged, permits the participant to rate and comment on the response from the high-profile individual. The rating will be incorporated by the rating unit 333 into an overall rating of the high-profile individual, which will be displayed to a user via the high-profile individual biographical profile interface 700. The comment will be incorporated by the rating unit 333 into a list of user comments 718, which can be viewed by users prior to making an offer for a response from the high-profile individual.

The actual response provided by the high-profile individual can be provided to the user in a personalized format, such as a collectible-type personalized letterhead with, for example, a digital signature from the high-profile individual. One skilled in the art will recognize that the response message 1118 can be formatted in any desirable format without departing from the scope of the present invention.

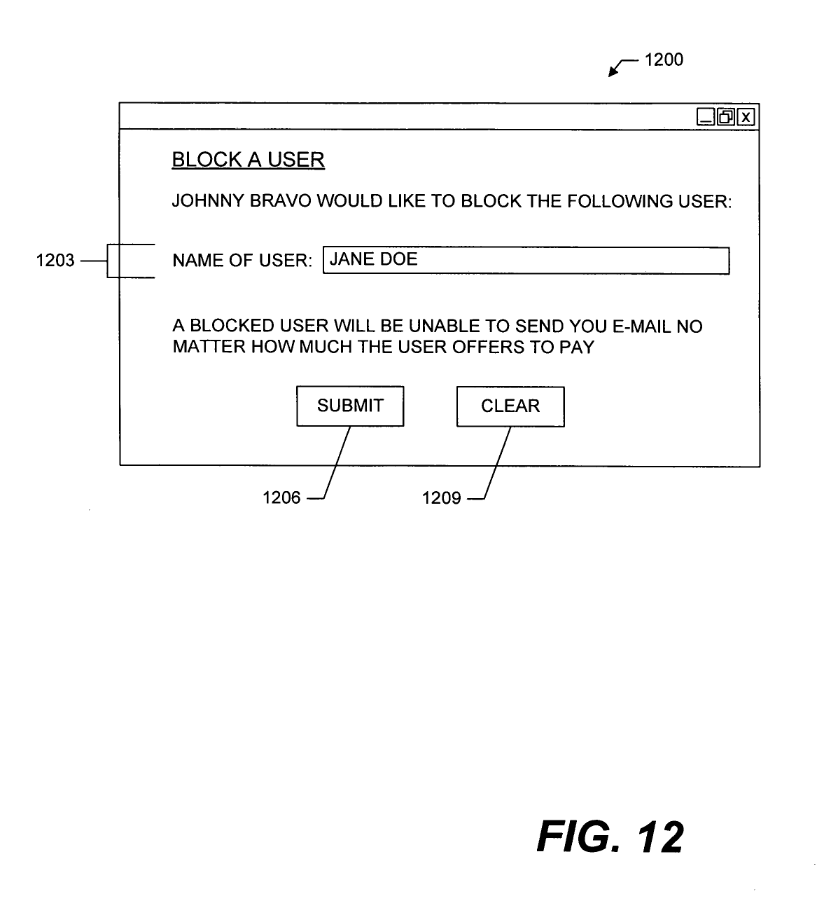

FIG. 12 displays a pictorial representation of a high-profile individual communication block interface 1200 in accordance with some embodiments of the present invention. Upon request, the data management unit 309 provides a high-profile individual with a high-profile individual communication block interface 1200, which permits the high-profile individual to block communications from a particular participant. The high-profile individual communication block interface 1200 may include, but is not limited to, a block user field 1203, a submit button 1206, and a clear button 1209. The block user field 1203 accepts the name, alias, or e-mail address of a participant that the high-profile individual refuses to receive communications from. The submit button 1206, when engaged, provides the data within the block user field 1203 to the data management unit 309 and notifies the data management unit 309 that the specified participant should not be able to send future communications to the high-profile individual. The clear button 1209, when engaged, clears the data entered into the block user field 1203.

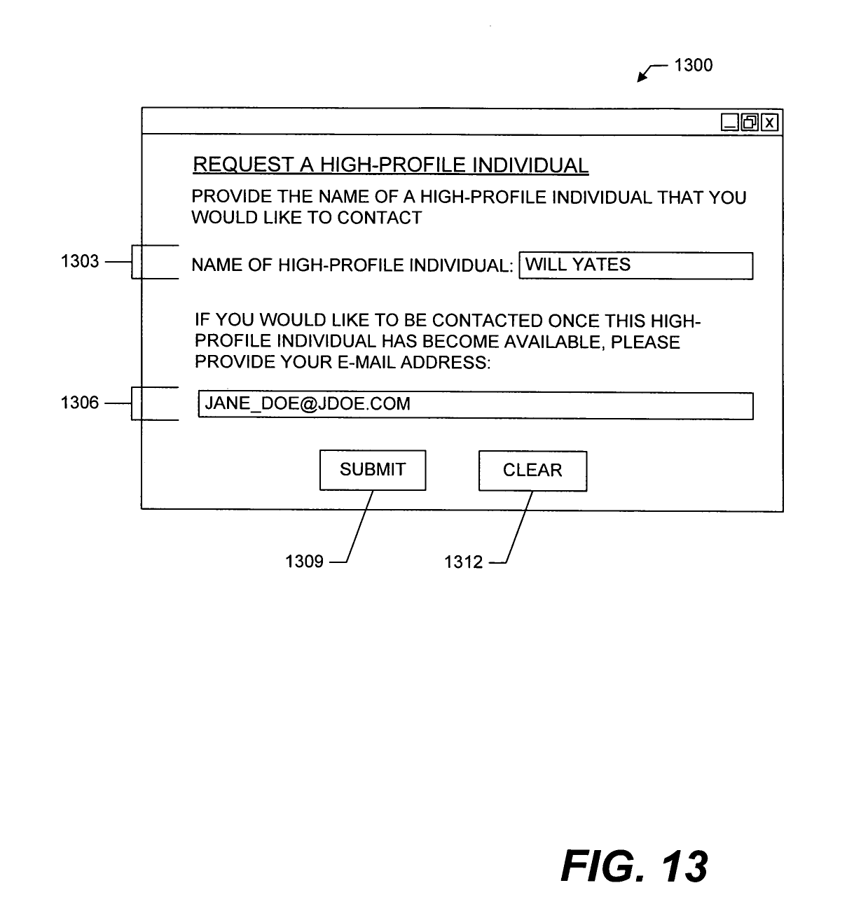

FIG. 13 displays a pictorial representation of a high-profile individual request interface 1300 in accordance with some embodiments of the present invention. When requested by a user, the data management unit 309 provides a high-profile individual request interface 1300 to the user. The high-profile individual request interface 1300 includes a high-profile individual name field 1303, a user e-mail address field 1306, a submit button 1309, and a clear button 1312. The high-profile individual name field 1303 allows a user to enter the name of a high-profile individual that the user would like to send a communication to (e.g., the high-profile individual is currently not registered with the high-profile individual communication system 300). The user e-mail address field 1306 allows the user to submit his or her e-mail address, if he or she would like to receive an e-mail notification when the requested high-profile individual has registered with the high-profile individual communication system 300. The submit button 1309, when engaged, provides the high-profile individual name and the user e-mail address to the data management unit 309. The data management unit 309 provides the data to the memory storage device 312 for storage. If a predetermined amount of interest exists for a particular high-profile individual, then an invitation may be sent to the high-profile individual, inviting the high-profiled individual to register with the high-profile individual communication system 300. The clear button 1312, when engaged, removes any data entered within the high-profile individual name field and the user e-mail address field.

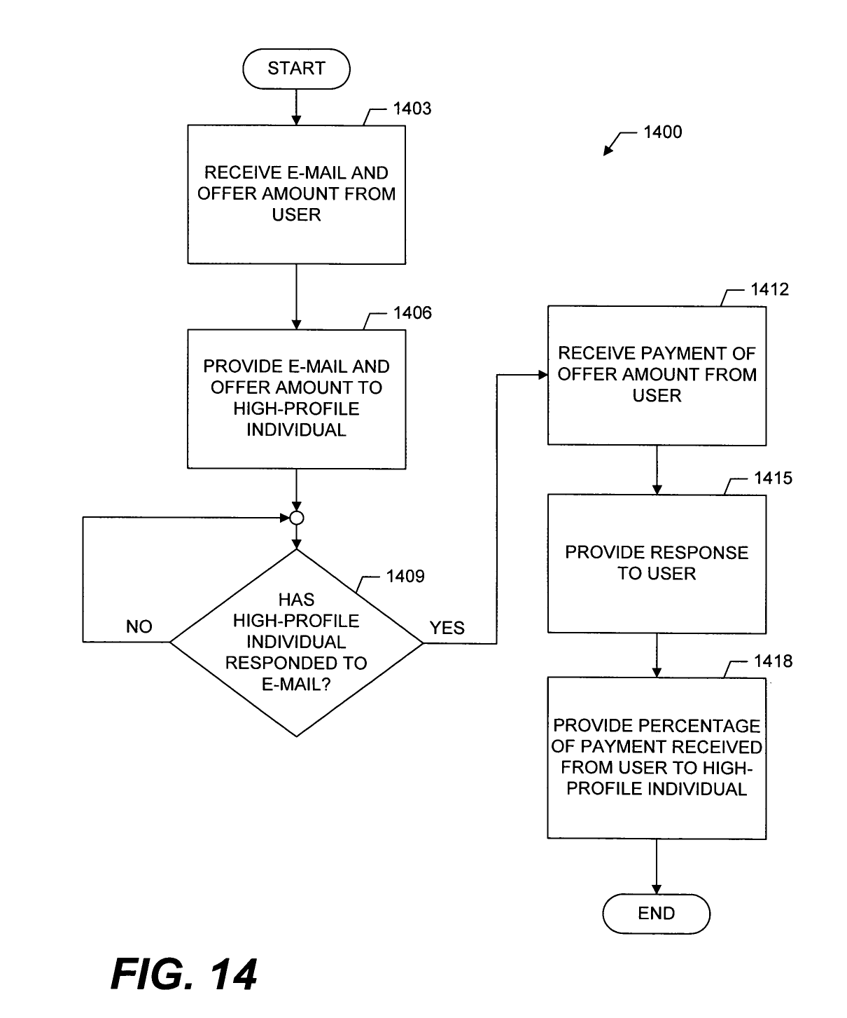

FIG. 14 displays a logic flow diagram representing a method 1400 of communicating with a high-profile individual in accordance with some embodiments of the present invention. The high-profile individual communication system 300 provides a unique system for users to communicate with high-profile individuals who previously were nearly impossible to communicate with. By allowing participants to make an offer amount to entice the high-profile individual to respond to a communication from the participant, high-profile individuals can, without any obligation, monetarily benefit from responding to communications received from participants.

The method 1400 of communicating with a high-profile individual begins at 1403, where the data management unit 309 receives a communication (e.g., an email) and an offer amount from a user (e.g., participant) via the user communication interface 800. At 1406, the message management unit 330 provides the received communication and the offer amount to a high-profile individual through the high-profile individual communication selection interface 900. Next, at 1409, the data management unit 309 determines whether the high-profile individual has responded to the received communication. If, at 1409, the data management unit 309 determines that the high-profile individual has not responded to the received communication, then the data management unit 309 proceeds to 1409, described above. If, however, at 1409 the data management unit 309 determines that the high-profile individual has responded to the received communication (e.g., submitted a response via the high-profile individual communication interface 1000), then the data management unit 309 proceeds to 1412 where the data management unit 309 receives payment of the offer amount from the user. As described above, the data management unit 309 receives payment of the offer amount using the designated payment method, which may include, but is not limited to, a credit card, an online payment service, a financial institution 336 (e.g., wire transfer), or any other appropriate payment method. Only after receiving the offer amount from the user will the data management unit 309 proceed to 1415 where the message management unit 330 provides the received response to the user through use of the user communication display and rating interface 1100. Providing the received response to the user through the use of the user communication display and rating interface 1100, may include sending an e-mail to the user's personal e-mail account indicating that a response is available to the user for viewing. Then, at 1418, the data management unit 309 provides a predetermined percentage of the received offer amount to the high-profile individual. The data management unit 309 provides the percentage of the offer amount by a predetermined payment method, such as, but not limited to, a check by mail, direct deposit, or an online payment service. The data management unit 309 then terminates operation in accordance with method 1400.

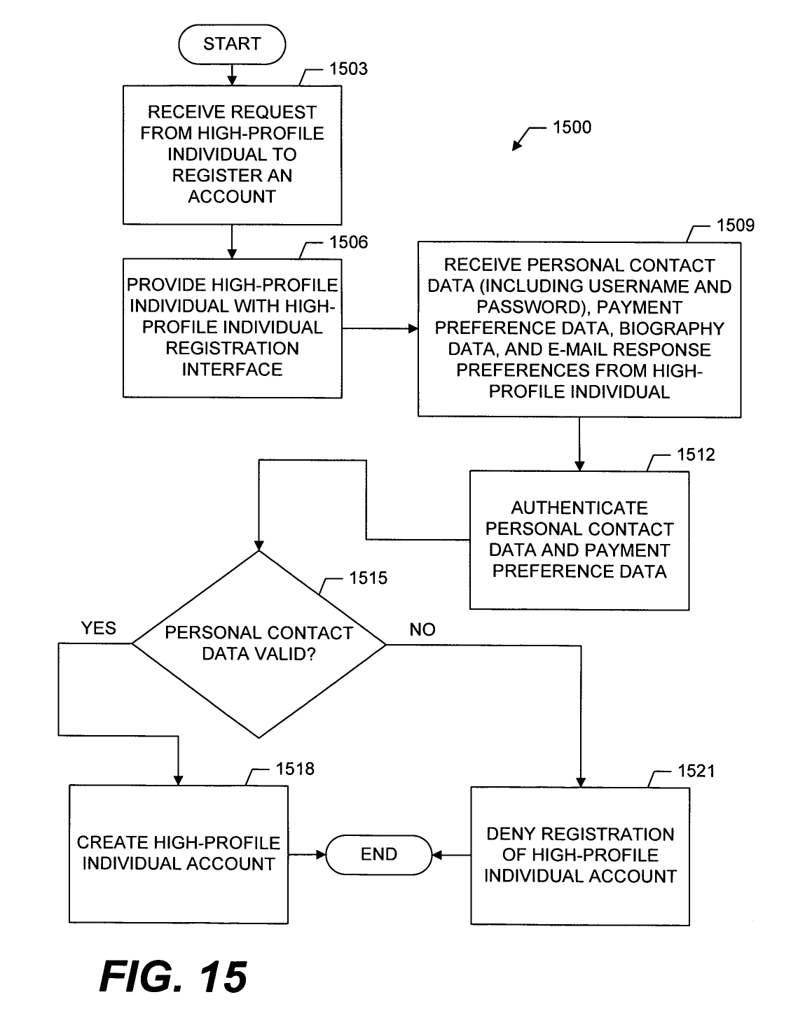

FIG. 15 displays a logic flow diagram representing a method 1500 of creating a high-profile individual account in accordance with some embodiments of the present invention. Typically, participants (e.g., registered users) may only communicate with high-profile individuals who have created accounts on the high-profile individual communication system 300. Registered high-profile individuals are provided with access to communications sent by participants and are provided with a predetermined percentage of the offer amount upon responding to a communication from a participant.

The method 1500 of creating a high-profile individual account begins at 1503 where the data management unit 309 receives a request from a high-profile individual to register an account. Next, at 1506, the data management unit 309 provides the high-profile individual with a high-profile individual account registration interface 500. Then, at 1509, the data management unit 309 receives personal account data 503 including a username and password, payment preference data 506, biographical description data 515, and response description data 518 from the high-profile individual. The data management unit 309 provides all of the received data to the account management unit 327. At 1512, the account management unit 327 authenticates the personal data 503 and payment preference data 506 (and all other received data, if necessary) received from the high-profile individual. The account management unit 327 attempts to ensure that the user submitting the data is the high-profile individual referenced in the personal data 503. At 1515, the account management unit 327 determines whether the personal contact data 503 is valid (e.g., is authentic). If, at 1515, the account management unit 327 determines that the personal contact data 503 is not valid, then the account management unit 327 proceeds to 1521 where the account management unit 327 denies registration of the high-profile individual account. The account management unit 327 then terminates operation in accordance with method 1500. If, however, at 1515 the account management unit 327 determines that the personal contact data 503 is valid, then the account management unit 327 proceeds to 1518 where the account management unit 327 creates the high-profile individual account by storing the received data on the account data unit 315 of the memory storage device 312. The account management unit 327 then terminates operation in accordance with method 1500.

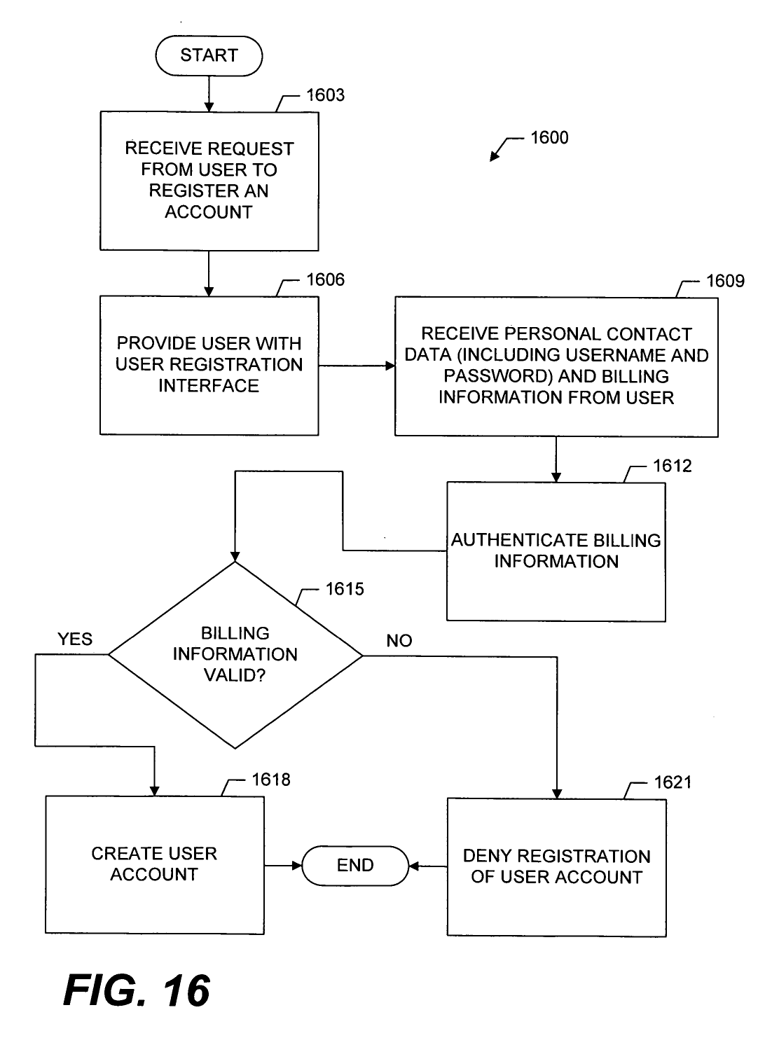

FIG. 16 displays a logic flow diagram representing a method 1600 of creating a user account in accordance with some embodiments of the present invention. Only registered users (e.g., participants) may communicate with high-profile individuals who have created accounts on the high-profile individual communication system 300. Registered users are provided with the functionality to submit a communication and offer amount to a high-profile individual and view and rate a response of the communication from the high-profile individual.

The method 1600 of creating a user account begins at 1603 where the data management unit 309 receives a request from a user to register for an account with the high-profile individual communication system 300. At 1606, the data management unit 309 provides the user with a user account registration interface 400. Then, at 1609, the data management unit 309 receives personal contact data 403 including a username and password and payment method data 406 (e.g., billing information) from the user. The data management unit 309 provides all of the received data to the account management unit 327. At 1612, the account management unit 327 authenticates the payment method data 406 (and the personal data 403, if necessary) of the user. The account management unit 327 is attempting to ensure that the user providing the data is really the user referenced in the personal data 403. At 1615, the account management unit 327 determines whether the payment method data 406 is valid. If, at 1615, the account management unit 327 determines that the payment method data 406 is not valid, then the account management unit 327 proceeds to 1621 where the account management unit 327 denies registration of the user account. The account management unit 327 then terminates operation in accordance to method 1600. If, however, at 1615 the account management unit 327 determines that the payment method data 406 is valid, then the account management unit 327 proceeds to 1618 where the account management unit 327 creates the user account by storing the received data in the account data unit 315 of the memory storage device 312. The account management unit 327 then terminates operation in accordance with method 1600.

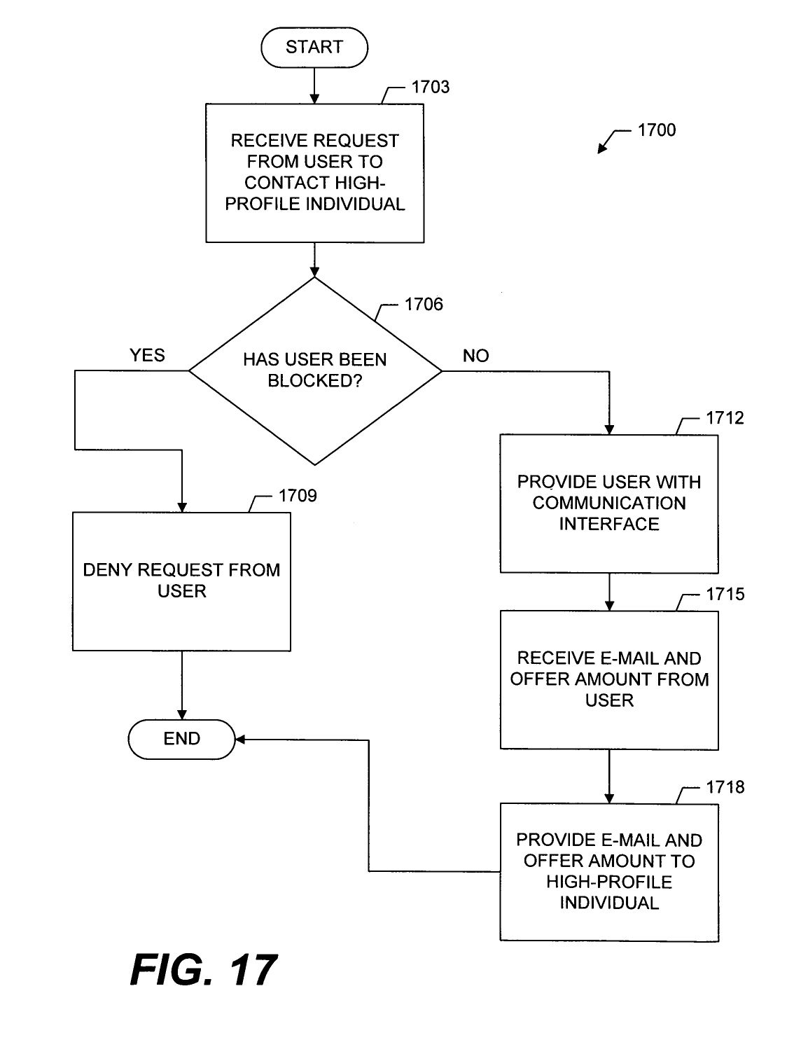

FIG. 17 displays a logic flow diagram representing a method 1700 of verifying a user for communication with a high-profile individual in accordance with some embodiments of the present invention. Even registered users do not necessarily get to communicate with all high-profile individuals. If a high-profile individual blocks a particular registered user (e.g., participant), then the registered user will not be permitted to submit a communication and offer amount to the high-profile individual. Accordingly, certain users, such as stalkers, may be banned from communicating with the high-profile individual.

The method 1700 of verifying a user for communication with a high-profile individual begins at 1703 where the data management unit 309 receives a request from a registered user to contact a high-profile individual. Such request is generally provided to the data management unit 309 via the send communication option 712 of the high-profile individual biographical profile interface 700 or by the user communication interface 800. The data management unit 309 provides the request to the account management unit 327 which, at 1706, determines whether the registered user has been blocked by the high-profile individual. A list of blocked users is associated with the account data of the high-profile individual stored in the account data unit 315 of the memory storage device 312. If, at 1706, the account management unit 327 determines that the registered user has been blocked, then the account management unit 327 proceeds to 1709 where the account management unit 327 denies the request from the user to communicate with the high-profile individual. If necessary, the data management unit 309 refuses any communication from the blocked user to the high-profile individual. The account management unit 327 then terminates operation in accordance to method 1700. If, however, at 1706 the account management unit 327 determines that the registered user has not been blocked, then the account management unit 327 proceeds to 1712 where the data management unit 309 provides the user with the user communication interface 800, if necessary. Next, at 1715, the data management unit 309 receives a communication and offer amount from the user and provides the communication and offer amount to the account management unit 327. At 1718, the account management unit 327 provides the communication and offer amount to the high-profile individual by, for example, storing the communication in the message data unit 321 of the memory storage device 312 and associating the communication with the account of the high-profile individual stored in the account data unit 315 of the memory storage device 312. The account management unit 327 then terminates operation in accordance with method 1700.

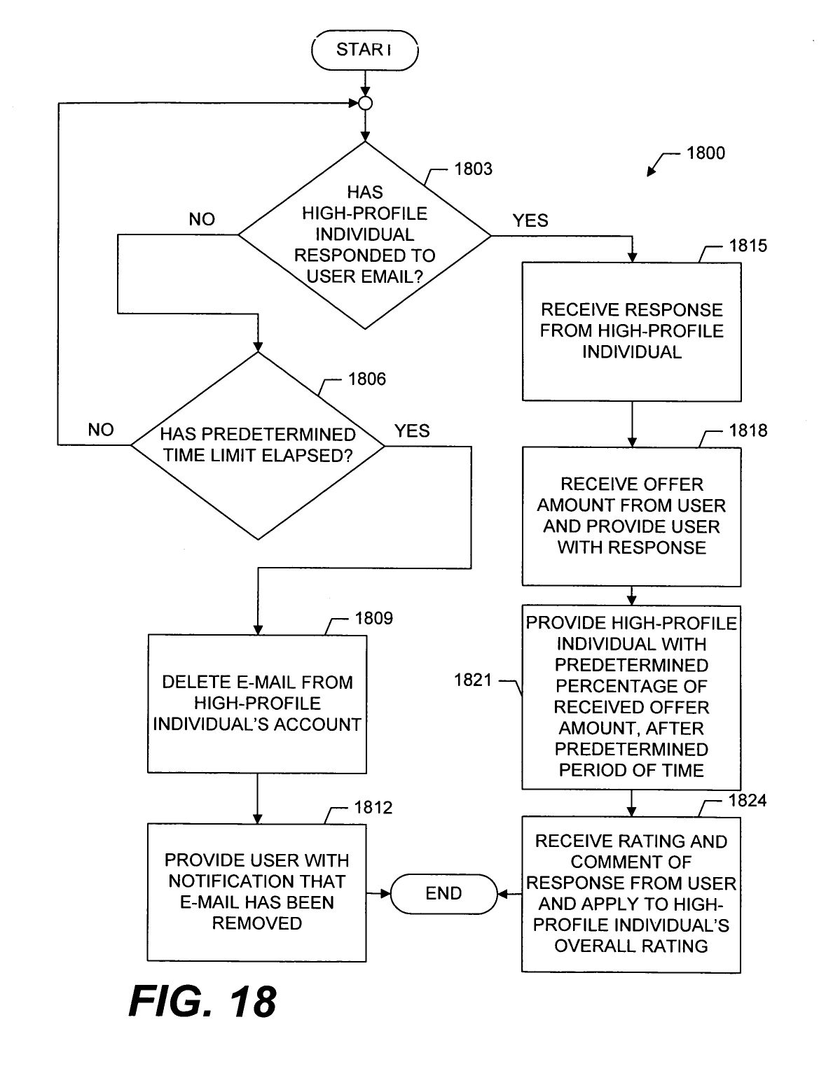

FIG. 18 displays a logic flow diagram representing a method 1800 of communicating with a high-profile individual with time limitations in accordance with some embodiments of the present invention. In situations where a high-profile individual has not responded to a communication submitted by a participant, the high-profile individual communication system 300 provides a time limit where a communication and offer amount expire, if not responded to by the high-profile individual before the time limit elapses.

The method 1800 of communicating with a high-profile individual with time limitations begins at 1803 where the data management unit 309 determines whether a high-profile individual has responded to a communication submitted by a participant. The data management unit 309 may check the transaction data unit 318 to determine whether a high-profile individual has responded to a communication by a participant, because a response is not provided to the participant until payment is received and the transaction is recorded in the transaction data unit 318 of the memory storage device 312. If, at 1803, the data management unit 309 determines that a high-profile individual has not responded to a communication submitted by a participant, then the data management unit 309 proceeds to 1806 where the data management unit 309 determines whether a predetermined time limit has elapsed from the time the participant submitted the communication. If, at 1806, the data management unit 309 determines that a predetermined time limit has not elapsed, then the data management unit 309 proceeds to 1803, described above. If, however, at 1806 the data management unit 309 determines that a predetermined time limit has elapsed, then the data management unit 309 proceeds to 1809 where the message management unit 330 deletes the communication from the message data unit 321 of the memory storage device 312 and removes the association of the communication with the account of the high-profile individual stored in the account data unit 315 of the memory storage device 312. Next, at 1812, the message management unit 330 provides the participant with a notification that the communication has been removed from consideration. The message management unit 330 may notify the participant by storing a notification message in the message data unit 321 of the memory storage device 312 and associating the notification message with the account of the participant stored in the account data unit 315 of the memory storage device 312. The memory storage device 312 then terminates operation in accordance with method 1800.

If, however, at 1803 the data management unit 309 determines that the high-profile individual has responded to the communication submitted by the participant, then the data management unit 309 proceeds to 1815 where the data management unit 309 receives the response from the high-profile individual via the high-profile individual communication interface 1000. Next, at 1818, the data management unit 309 receives payment of the offer amount from the participant and, subsequently, provides the response to the participant through the message management unit 330. Next, at 1821, the data management unit 309 provides the high-profile individual with a predetermined percentage of the received offer amount. Such predetermined percentage of the received offer amount may be provided to the high-profile individual after a predetermined period of time, to ensure that the response meets the requirements of the high-profile individual communication system 300 and the characteristics provided by the high-profile individual. At 1824, the data management unit 309 receives a rating and comment from the participant of the response of the high-profile individual. The data management unit 309 provides the rating and comment to the rating unit 333. The rating unit 333 applies the received rating with the overall rating of the high-profile individual stored with the account of the high-profile individual on the account data unit 315 of the memory storage device 312. The result of applying the new rating with the overall rating is then stored by the rating unit 333 on the account data unit 315 of the memory storage device 312. Additionally, the rating unit 333 stores the received comment with the account of the high-profile individual on the account data unit 315 of the memory storage device 312. The rating unit 333 then terminates operation in accordance with method 1800.

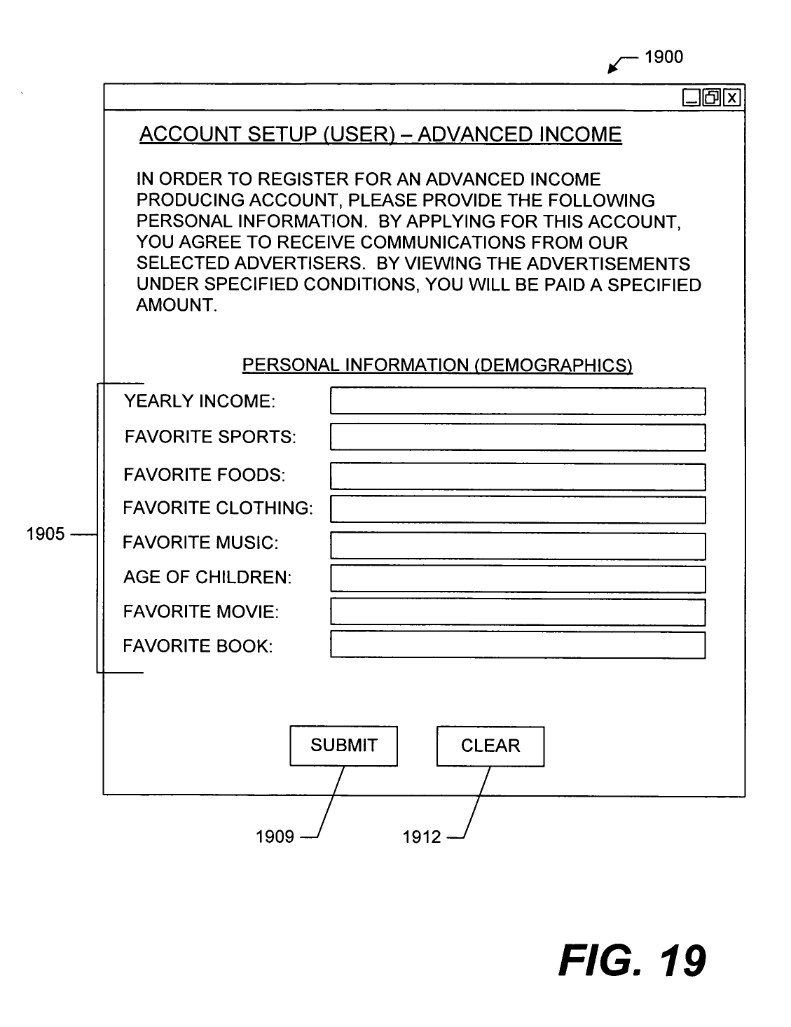

FIG. 19 displays a pictorial representation of an advanced income user account registration interface 1900 in accordance with some embodiments of the present invention. In addition to providing the registered high-profile individuals with an income stream, the high-profile individual communication system 300 provides a revenue based system for the registered participants or users. If a user designates an advanced income user account, the data management unit 309 provides an advanced income user account registration interface 1900 to the user. The advanced income user account registration interface 1900 includes additional personal information fields 1905 (e.g., demographic fields regarding the user) that will be used by predetermined advertisers for targeting specific advertisements to certain users of the high-profile individual communication system 300. The additional personal information fields 1905 can include, but are not limited to, yearly income, favorite sports, favorite foods, favorite clothing brands, favorite music (artists or genres), age of children (if any), favorite movies, and favorite books (title or authors). One skilled in the art will recognize that additional demographic information about a particular user can include other fields and information without departing from the scope of the present invention.

The submit button 1909, when engaged, provides the additional personal information (e.g., demographics) 1905 to the data management unit 309. The data management unit 309 provides the data to the memory storage device 312 for storage. The additional personal information 1905 can then be provided to participating advertisements in order to properly target users with advertisements. The clear button 1912, when engaged, removes any data entered within the personal information fields 1905.

Alternatively, the high-profile individual communication system 300 can include multiple levels of general advertisements to non-registered users, registered users, and high-profile individuals. For example, based on demographics of the user (registered or non-registered) or high-profile individual, an advertisement may be provided relating to a generic category (such as sports). The advertisement can be a more specific subcategory within the generic category (e.g., baseball). Further, the advertisement can be even more specific than the subcategory, such as an advertisement relating to a particular sports team, for example. Moreover, advertisements can be targeted to the high-profile individual, based on the high-profile individual's characteristics (such as the team or sport the high-profile individual is associated with, for example).

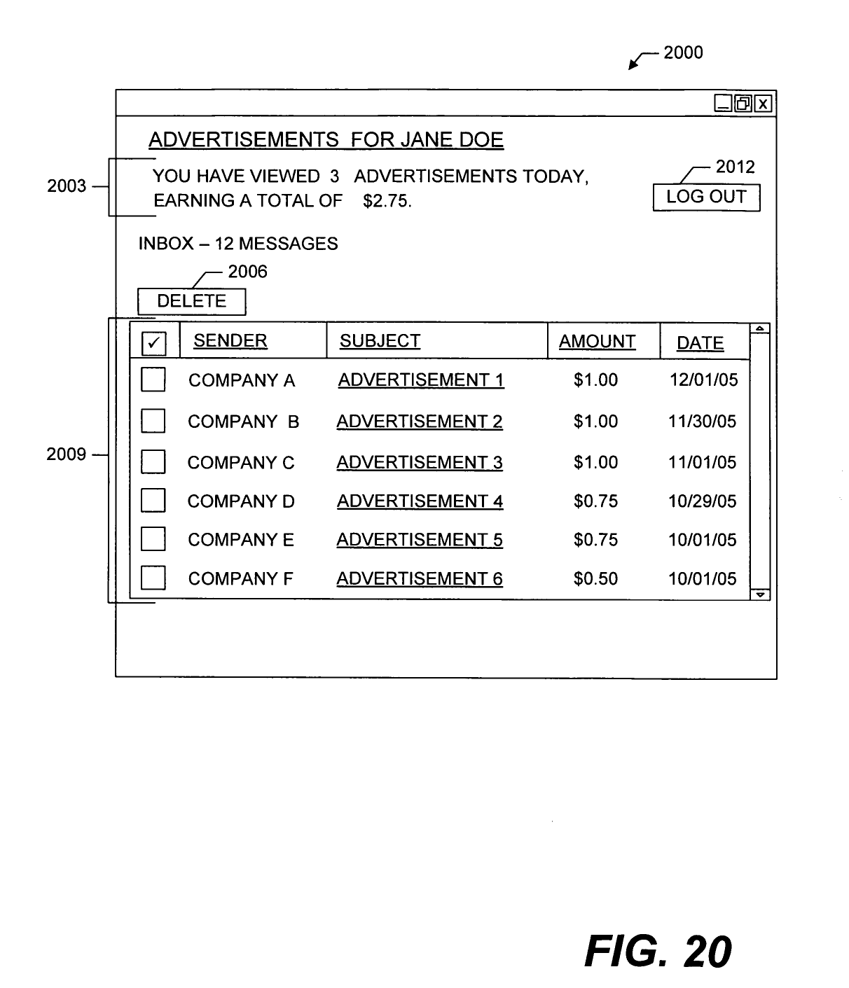

FIG. 20 displays a pictorial representation of a user advertisement selection interface 2000 in accordance with some embodiments of the present invention. The data management unit 309 provides a participating user with a user advertisement selection interface 2000 including a list of advertisements sent to the user from predetermined companies seeking to advertise products to the users of the high-profile individual communication system 300.

The user advertisement selection interface 2000 may include, but is not limited to, an advertisement view summary 2003, a delete advertisement option 906, a log out option 2012, and a list of advertisements and offer amounts from advertising companies 2009. The advertisement view summary 2003 may include, but is not limited to, the number of advertisements viewed and the amount earned from the current login session of the user. The advertisement view summary 2003 allows the user to keep track of the number of advertisements he or she has viewed and the amount he or she has earned by viewing the advertisements. The delete advertisement option 2006, when engaged, deletes all selected advertisements from the list of advertisements and offer amounts 2009, whether the user has viewed the advertisement or not. Generally, when the user views an advertisement, the corresponding entry within the list of advertisements and offer amounts 2009 is designated as being viewed by the user. The user personally determines which advertisements to view and, therefore, the advertisement with the highest offer amount does not necessarily guarantee that the user will view the advertisement. Although, a higher offer amount typically increases the likelihood that the user will, in fact, view the advertisement. The log out option 2012, when engaged, will log the user out of the current session, which will require the user to subsequently log back into the high-profile individual communication system 300. The list of advertisements and offer amounts 2009 may include, but is not limited to, the company name or alias of the company providing the advertisement, the subject of the advertisement, the offer amount for viewing the advertisement, and the date the advertisement was received. A user may be provided with a predetermined number of advertisements (e.g., the top one-hundred, based on offer amount) and, therefore, an advertisement and offer amount may not be received or considered by the user.

If the user selects the subject of an advertisement, the message management unit 330 provides the user with the advertisement from the predetermined company, which allows the user to view the advertisement, if so desired.

In operation, the user provides additional personal information 1905, such as demographics of the user. The high-profile individual communication system 300 then provides the additional personal information 1905 to selected advertisers (advertising companies), which can use the additional personal information 1905 to target specific users (e.g., customers). The advertisers send the determined users with an advertisement to view with an offer amount. The offer amount is the amount the advertiser is willing to pay the user for viewing the advertisement. To ensure that the user adequately views the advertisement in order to receive the offer amount, the advertisement can use codes or imbedded information to ensure that the user adequately viewed the advertisement, prior to the advertiser paying the user for viewing the advertisement. Accordingly, the high-profile individual communication system 300 may retrieve payment information from the user in order to credit the user with the payment from the advertisers for viewing the advertisements.

Whereas the present invention has been described in detail it is understood that variations and modifications can be effected within the spirit and scope of the invention, as described herein before and as defined in the appended claims. The corresponding structures, materials, acts, and equivalents of all mean-plus-function elements, if any, in the claims below are intended to include any structure, material, or acts for performing the functions in combination with other claimed elements as specifically claimed.

What is claimed is:

1. A method of providing access to a high-profile individual, the method comprising:
receiving a communication from a participant, wherein said communication includes an offer amount;
providing said communication to a high-profile individual; and
if said high-profile individual responds to said communication, performing a sequence comprising:
receiving a payment from said participant, wherein the value of said first payment is equal to said offer amount; and
providing said response to said participant.

2. The method of claim 1, wherein said sequence further comprises:
providing a payoff to said high-profile individual, wherein the value of said payoff is equal to a predetermined percentage of said offer amount.

3. The method of claim 1, wherein said communication includes electronic mail (e-mail).

4. The method of claim 1, wherein said response includes a webpage to be viewed by participant.

5. The method of claim 1, wherein said response is provided to said participant after said payment is received from said participant.

6. The method of claim 1, the method further comprising:
creating a first account for said high-profile individual; and
creating a second account for said participant, wherein said communication from said participant is provided to said first account and said response from said high-profile individual is provided to said second account.

7. The method of claim 6, wherein creating a first account for said high-profile individual comprises:
receiving a registration request from said high-profile individual;
providing said high-profile individual with a high-profile individual registration interface;
receiving a plurality of personal contact data from said high-profile individual through said high-profile individual registration interface;
authenticating said plurality of personal contact data;
if said plurality of personal contact data is valid, creating said first account using said plurality of personal contact data.

8. The method of claim 7, wherein said plurality of personal contact data includes a username and a password.

9. The method of claim 7, wherein said plurality of personal contact data includes a receipt of payment option.

10. The method of claim 6, wherein creating a second account for said participant comprises:
receiving a registration request from said participant;
providing said participant with a participant registration interface;
receiving a plurality of personal contact data from said participant through said participant registration interface;
authenticating said plurality of personal contact data;
if said plurality of personal contact data is valid, creating said second account using said plurality of personal contact data.

11. The method of claim 10, wherein said plurality of personal contact data includes a username and a password.

12. The method of claim 10, wherein said plurality of personal contact data includes a provide a payment option.

13. The method of claim 1, the method further comprising:
determining whether said high-profile individual has blocked said participant; and
if said high-profile individual has blocked said participant, performing a sequence comprising:
refusing said communication from said participant, wherein said communication is not provided to said high-profile individual; and
providing said participant with a denial notification.

14. The method of claim 1, the method further comprising:
determining whether a predetermined time has elapsed before said high-profile individual responds to said communication; and
if said predetermined time has elapsed before said high-profile individual responds to said communication, performing a sequence comprising:
deleting said communication from said participant, wherein said communication cannot be responded to by said high-profile individual; and
providing said participant with a elapsed-time notification.

15. The method of claim 1, wherein said providing said response to said participant only occurs after said receiving said first payment from said participant.

16. The method of claim 1, the method further comprising:
receiving a rating and a comment of said response from said participant.

17. A system of providing access to a high-profile individual, the system comprising:
a data management unit operable for receiving a communication from a first subscriber, wherein said communication is directed to a second subscriber and includes an offer amount;
a memory storage device operable for storing said communication;
a message management unit operable for providing a plurality of communications to a second subscriber, wherein said plurality of communications include said communication; and
wherein said data management unit is further operable for receiving a payment equal to said offer amount from said first subscriber and providing a response to said communication from said second subscriber to said first subscriber.

18. The system of claim 17, the system further comprising:
an account management unit operable for creating a first subscriber account based on personal data received from said first subscriber and a second subscriber account based on personal data received from said second subscriber, wherein said account management unit provides personal data of said first subscriber and personal data of said second provider to said memory storage device for storage.

19. The system of claim 18, the system further comprising:
an authentication unit operable for validating authentication data from said first subscriber and said second subscriber, wherein validating authentication data includes comparing said authentication data with corresponding said personal data.

20. The system of claim 17, the system further comprising:
a message management unit operable for providing a plurality of communications to said second subscriber, wherein said plurality of communications includes said communication.

21. The system of claim 17, the system further comprising:
a rating unit operable for receiving a rating and comment by said first subscriber of said response from said second subscriber, wherein said rating and comment is provided to said memory storage device for storage.

22. There system of claim 17, wherein said data management unit is further operable for refusing said communication from said first subscriber if said second subscriber has blocked communication from said first subscriber.

23. The system of claim 17, wherein said data management unit is further operable for deleting said communication from said memory storage device if a predetermined time limit has elapsed prior to said second subscriber responding to said communication.

24. The system of claim 17, wherein said data management unit is further operable for providing a payoff amount to said second subscriber after receiving said response from said second provider, wherein said payoff amount equals the value of a predetermined percentage of said offer amount.

25. A computer-readable medium for providing access to a high-profile individual having computer executable instructions, the computer executable instructions comprising:
receiving a communication from a participant, wherein said communication includes an offer amount;
providing said communication to a high-profile individual; and
if said high-profile individual responds to said communication, performing a sequence comprising:
receiving a payment from said participant, wherein the value of said first payment is equal to said offer amount; and
providing said response to said participant.

26. The computer-readable medium of claim 25, said sequence further comprising:
providing a payoff to said high-profile individual, wherein the value of said payoff is equal to a predetermined percentage of said offer amount.

27. The computer-readable medium of claim 25, wherein said communication includes electronic mail (e-mail).

28. The computer-readable medium of claim 25, the computer executable instructions further comprising:
creating a first account for said high-profile individual; and
creating a second account for said participant, wherein said communication from said participant is provided to said first account and said response from said high-profile individual is provided to said second account.

29. The computer-readable medium of claim 28, wherein creating a first account for said high-profile individual comprises:
receiving a registration request from said high-profile individual;
providing said high-profile individual with a high-profile individual registration interface;
receiving a plurality of personal contact data from said high-profile individual through said high-profile individual registration interface;
authenticating said plurality of personal contact data;
if said plurality of personal contact data is valid, creating said first account using said plurality of personal contact data.

30. The computer-readable medium of claim 29, wherein said plurality of personal contact data includes a username and a password.

31. The computer-readable medium of claim 29, wherein said plurality of personal contact data includes a receipt of payment option.

32. The computer-readable medium of claim 28, wherein creating a second account for said participant comprises:
receiving a registration request from said participant;
providing said participant with a participant registration interface;
receiving a plurality of personal contact data from said participant through said participant registration interface;
authenticating said plurality of personal contact data;
if said plurality of personal contact data is valid, creating said second account using said plurality of personal contact data.

33. The computer-readable medium of claim 32, wherein said plurality of personal contact data includes a username and a password.

34. The computer-readable medium of claim 32, wherein said plurality of personal contact data includes a provide a payment option.

35. The computer-readable medium of claim 25, the computer executable instructions further comprising:
determining whether said high-profile individual has blocked said participant; and
if said high-profile individual has blocked said participant, performing a sequence comprising:
refusing said communication from said participant, wherein said communication is not provided to said high-profile individual; and
providing said participant with a denial notification.

36. The computer-readable medium of claim 25, the computer-executable instructions further comprising:
determining whether a predetermined time has elapsed before said high-profile individual responds to said communication; and
if said predetermined time has elapsed before said high-profile individual responds to said communication, performing a sequence comprising:
deleting said communication from said participant, wherein said communication cannot be responded to by said high-profile individual; and
providing said participant with a elapsed-time notification.

37. The computer-readable medium of claim 25, wherein said providing said response to said participant only occurs after said receiving said first payment from said participant.

38. The computer-readable medium of claim 25, the computer executable instructions further comprising:
receiving a rating of said response from said participant.
